(19) United States
(12) Patent Application Publication
(10) Pub. No.: US 2015/0142863 A1
(43) Pub. Date: May 21, 2015

(54) SYSTEM AND METHODS FOR DISTRIBUTED DATA STORAGE

(71) Applicant: SINGAPORE UNIVERSITY OF TECHNOLOGY AND DESIGN, Singapore (SG)

(72) Inventors: Chau Yuen, Singapore (SG); Tam Van Vo, Singapore (SG); Xiaohu Wu, Singapore (SG); Xiumin Wang, Singapore (SG); Wentu Song, Singapore (SG); Son Hoang Dau, Singapore (SG); Jaume Pernas, Singapore (SG)

(21) Appl. No.: 14/409,991

(22) PCT Filed: Jun. 19, 2013
(86) PCT No.: PCT/SG2013/000255

§ 371 Date: Dec. 19, 2014

(30) Foreign Application Priority Data
Jun. 20, 2012 (SG) 201204599-3

(51) Int. Cl. G06F 17/30; H04L 29/08

(52) U.S. Cl. CPC G06F 17/30194; H04L 67/1097
USPC 707/827

(57) ABSTRACT

A systematic distributed storage system (DSS) comprising: a plurality of storage nodes, wherein each storage node configures to store a plurality of sub blocks of a data file and a plurality of coded blocks, a set of repair pairs for each of the storage nodes, wherein the system is configured to use the respective repair pair of storage nodes to repair a lost or damaged sub block or coded block on a given storage node. Also a distributed storage system DSS comprising h non-empty nodes, and data stored non homogenously across the non-empty nodes according to the storing codes (n,k). Further a method for determining linear erasure codes with local repairability comprising: selecting two or more coding parameters including r and δ; determining if an optimal [n, k, d] code having all-symbol (r, δ)-locality (“(r, δ)ₐ”) exists for the selected r, δ; and if the optimal (r, δ)ₐ code exists performing a local repairable code using the optimal (r, δ)ₐ code.

### FIELD OF THE INVENTION

The present invention generally relates to data storage, and more particularly though not exclusively relates to systems and methods for non-homogeneous distributed data storage, non-maximum distance separable (MDS) distributed data storage, and locally repairable codes.

### BACKGROUND OF THE DISCLOSURE

Cloud storage or distributed storage systems (DSS) are becoming more popular because they allow users to access the stored information from anywhere. Since the information is being stored at multiple remote servers, it is safe as it is not subject to a single point of failure as compared to local storage. Although local storage cost is inexpensive, to store equivalent amounts of data in the cloud or at a data centre can be expensive. The higher cost is typically due to the communication bandwidth and the reliability built into the system to ensure that it is rarely subject to failures due to natural disasters, hardware failures, or power blackout. Besides requiring low storage cost and high security, a DSS needs to be robust such that when a node fails, it can be repaired within a short period of time. In addition, based on data content, there are various data storage requirements as summarized in Table 1.

TABLE 1

| | | Data | Data |
|---|---|---|---|
| | Data | Update | Access |
| Content type | Size | Freq | Freq |
| Data | Small | High | High |
| Multimedia | Medium | Low | Medium |
| Backup | Large | Medium | Low |

Thus, what is needed are highly recoverable and relatively impervious to failure data storage methods and systems for distributed storage systems. Furthermore, other desirable features and characteristics will become apparent from the subsequent detailed description, taken in conjunction with the accompanying drawings and this background of the disclosure.

### SUMMARY

In general terms in a first aspect the invention proposes a non-homogeneously distributed data storage. In a second aspect the invention proposes a distributed data storage using repair pairs, XOR based coding and/or non MDS coding. In a third aspect the invention proposes locally repairable codes for a range of coding parameters where the field size is minimised.

In a first specific expression of the invention there is provided a systematic distributed storage system (DSS) comprising

a plurality of storage nodes, wherein each storage node configures to store a plurality of sub-blocks of a data file and a plurality of coded blocks; and

a set of repair pairs for each of the storage nodes;

wherein the system is configured to use the respective repair pair of storage nodes to repair a lost or damaged sub-block or coded block on a given storage node.

In a second specific expression of the invention there is provided a distributed storage system DSS comprising

h non-empty nodes; and

data stored non-homogenously across the non-empty nodes according to the storing codes (n,k).

In a second specific expression of the invention there is provided a method for determining linear erasure codes with local repairability comprising

selecting two or more coding parameters including r and δ;

determining if an optimal [n, k, d] code having all-symbol (r, δ)-locality (“(r, δ)ₐ”) exists for the selected r, δ; and

if the optimal (r, δ)ₐ code exists performing a local repairable code using the optimal (r, δ)ₐ code.

One or more embodiments may be implemented according to any of claims 2 to 7, 9 to 18 and 20 to 25.

### BRIEF DESCRIPTION OF THE DRAWINGS

The invention will now be described, by way of example only, with reference to the figures, of which:

FIGS. 1A and 1B are schematic diagrams of an architecture for a DSS system;

FIG. 2 is a schematic diagram of a typical encoding structure for DSS;

FIG. 3 is a flow diagram of the selection of DSS system parameters based on content and encoding scheme;

FIG. 4 is a schematic diagram of the encoding process for each data block;

FIG. 5 is a schematic diagram of the repair process when one node fails;

FIG. 6 is a schematic diagram of the repair process when one node fails;

FIG. 7 is a schematic diagram of 1 node failure repair using scheme A based on (5, 3) MDS codes in non-homogeneous distributed storage systems;

FIG. 8 is a schematic diagram of 1 node failure repair, where the total repair bandwidth is M/2 and is smaller than the bound;

FIG. 9 is a schematic diagram of 1 node failure repair using scheme B based on (5, 3) MDS codes in non-homogeneous distributed storage systems;

FIG. 10A is a schematic diagram of 2 nodes failure repair using scheme A in non-homogeneous distributed storage system;

FIG. 10B is a schematic diagram of 2 nodes failure repair using scheme C in non-homogeneous distributed storage system;

FIG. 11 is a schematic diagram of data allocation using (8,5) MDS code in homogeneous DSS and non-homogeneous DSS;

FIG. 12 is a graph comparing of data availability between super-node non-homogeneous DSS and homogeneous DSS;

FIG. 13 is a schematic diagram of repairing failure when n=h(n k) in the (n=6,k=4,h=3) non-homogeneous DSS;

FIG. 14. An example of repair multi-failures based on (n=8,k=5,r=2) MSR codes using 3 storage nodes;

FIG. 15. A comparison of data availability between minimum-spread non-homogeneous DSS and homogeneous DSS;

FIG. 16 is a schematic diagram of how a locally repairable linear code is used to construct a distributed storage system: a file F is first split into five packets of equal size {x₁, . . . , x₅} and then is encoded into 12 packets, using a (2,3)ₐ linear code. These 12 encoded packets are stored at 12 nodes {v₁, . . . , v₁₂}, which are divided into three groups {v₁,v₂,v₃,v₄}₅ {v₅,v₆,v₇,v₈} and {v₉,v₁₀,v₁₁,v₁₂}. Each group can perform local repair of up to two node failures. For example, if node v₉ fails, it can be repaired by any two packets among v₁₀, v₁₁ and v₁₂. Moreover, the entire file F can be recovered by five packets from any five nodes vᵢ₁, . . . , vᵢ₅ which intersect each group with at most two packets. For example, F can be recovered from five packets stored at v₁, v₃, v₇, v₈ and v₁₀;

FIG. 17 is a schematic diagram of optimal (r,δ)ₐ linear codes;

FIG. 18 is an (A; ψ)-frame, where n=37; r=δ=3; t=8; A₁={1; 2; 3}, A₂={4; 5};B={6; 7; 8}; A={A₁;A₂;B} and ψ={1; 14}.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description of the invention.

The following definitions will be used through the description:
M block size
m number of blocks
q field size
k number of sub-blocks for each block of size M,
n number of coded blocks, also number of nodes
C level of redundancy (number of tolerable node failures)
d repair degree
F₂ the finite field of two elements
r the parameter that determines C, C=2^{r}−1
k′ k′=k/r
z coded blocks
o original blocks
j 1≦j≦n, index of the coded blocks
i 1≦i≦k′, one index of the original blocks
l running index in the sum
x systematic coded blocks
t number of node failures
s systematic node
p parity node
h non-empty nodes
V repair matrix
T used on the right-upper of a matrix to denote the transpose of it
w node's weight
y number of downloaded blocks from node i
p node's online probability
α storage size at node i
δ update bandwidth
G a generating matrix of a linear code
Ω an index set used in a certain round of a process
Λ the set of subsets of {1, 2, . . . , n} that satisfy a certain properties.
γ repair bandwidth of failure node i
f block i divided from file of size M
β downloaded packet from node i
A one possible combinations of online nodes
F_{q} the finite field of q elements.
S a subset of the set {1, 2, . . . , n}

The present embodiment proposes methodologies, namely Non-MDS DSS or XOR based DSS, Non-Homogeneous DSS, and Locally repairable codes. XOR based DSS is best suitable for data storage and peer-to-peer backup system, while Non-Homogeneous and Locally repairable DSS is best suitable for backup system. Table 2 summarizes the applicability of these two schemes to various data content.

TABLE 2

| | | Data | Data | |
|---|---|---|---|---|
| | Data | Update | Access | Proposed |
| Content type | Size | Freq | Freq | Technology |
| Data | Small | High | High | Non-MDS DSS |
| Multimedia | Medium | Low | Medium | |
| Backup | Large | Medium | Low | Non-Homogenous |
| | | | | DSS |
| | | | | Locally Repairable |
| | | | | Code |
| Backup | | | | Non-MDS DSS |
| (peer-to-peer) | | | | |

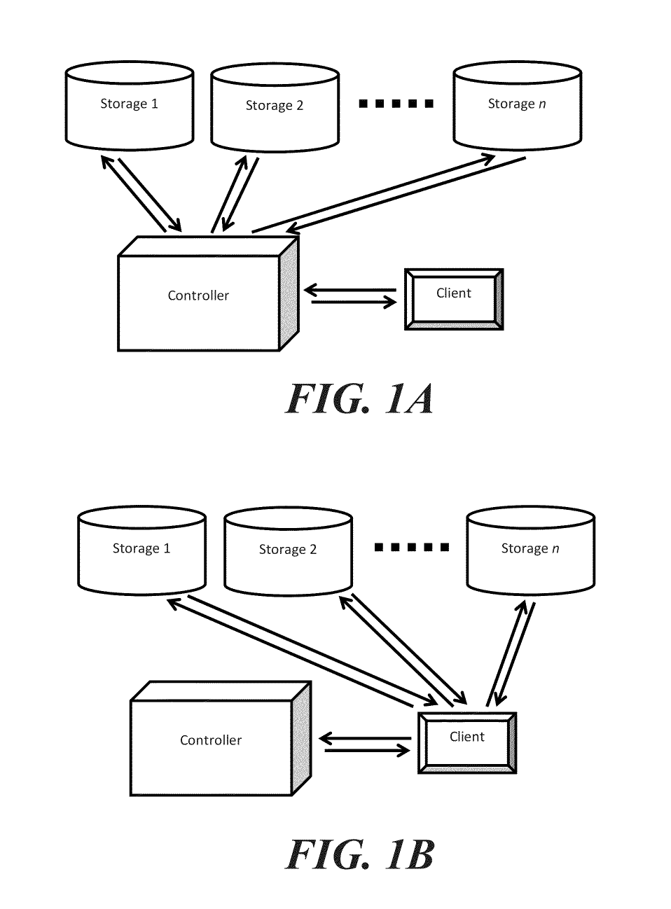

In accordance with the present embodiment, two DSS architectures are presented in FIGS. 1A and 1B. In FIG. 1A, a controller centric architecture is depicted. In this architecture, the client only deals with the controller and the controller will distribute, store, and retrieve information on behalf of the client. Referring to FIG. 1B, a client centric architecture is presented. In this architecture, the controller gives the client information about the distributed storage servers and client stores and retrieves the information directly to/from the distributed storage servers. The same architecture used for distributing, storing, and retrieving information can be applied when repairing a failed storage node in the DSS. Operation in accordance with the present embodiment can be implemented in either of the two architectures.

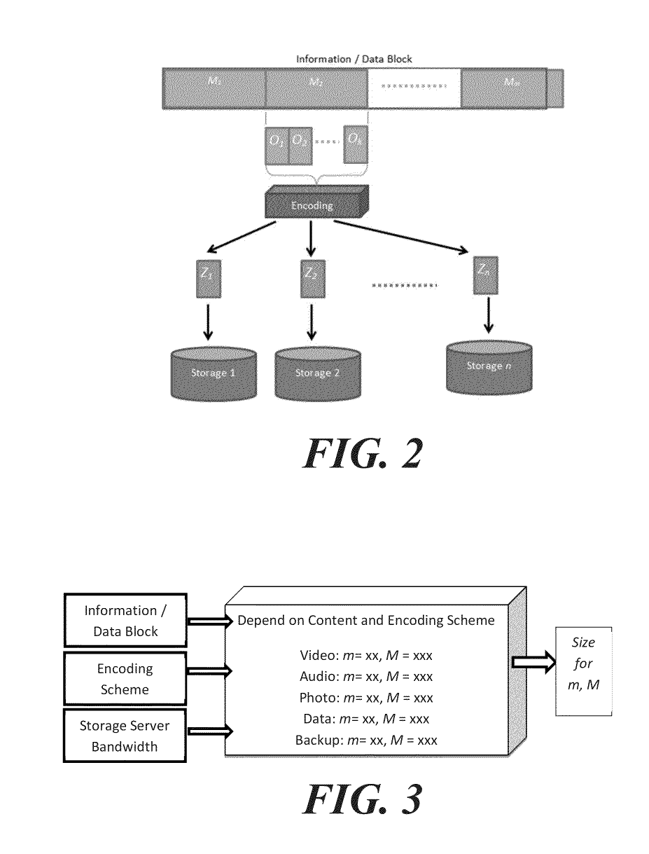

FIG. 2 depicts a typical DSS encoding structure. An information/data block is divided into m blocks of size M each (m≧1). The size of mM could be more than the size of the information block due to some constraints imposed on M for some encoding schemes. Each block of size M is further divided into k sub-blocks, and these k sub-blocks are encoded into n coded blocks of encoded data to be stored on n distributed storage servers, termed “nodes”.

Referring to FIG. 3, a methodology to determine the size for m and M in accordance with one aspect of the present embodiment is depicted. The size of m and M can be determined based on the encoding scheme, the storage server bandwidth, and the content type of the information/data block. For example, for photographic and audio data, m can be set as l, and M can be rounded to the nearest integer. Hence, the allowable value for M within an encoding scheme is preferably small.

Hereinafter, three architectures for DSS which permit dynamic selection of file fragment size in response to encoding scheme, storage server bandwidth, and file content type in accordance with the present embodiment will be discussed: XOR based DSS, Non-Homogeneous DSS, and Locally Repairable DSS.

XOR Based Distributed Storage with Binary Simplex Code

In a data centre, there may be three requirements that need to be satisfied. First, when the user wants to retrieve the original data, he should be able to obtain it as soon as possible. This requirement may be important. Next, the update complexity of the code should be as low as possible because the user may modify the data frequently. And last, minimization of storage space used so as to reduce the cost of energy consumption and the number of devices, while still tolerating a certain number of node failures.

Four types of redundancy schemes can be considered to implement this aspect of the present embodiment: (1) Replication, (2) Reed-Solomon codes, (3) Regenerating codes, and (4) Self-Repairing codes. Replication is the de facto standard for redundancy implementations, but it has a large storage cost. For example, if a system is to tolerate C node failures, C copies of the original data need to be stored. Both Reed-Solomon codes and regenerating codes are maximum distance separable (MDS) codes. In other words, when a file (or a portion of file) consisting of k blocks is encoded into n coded blocks and each coded block is stored at a unique physical node, connecting to any k nodes can recover the original file and the system can tolerate any n k nodes failure. However, Reed-Solomon codes and regenerating codes both have a high update complexity. In addition, given the fact that the decoding is done over a larger field, these two codes together with self-repairing codes have high decoding complexity when the user retrieves the original data. Hence, Reed-Solomon codes, regenerating codes and self-repairing codes cannot guarantee the first two requirements set out above, making them unfit for data centre application.

In accordance with the present embodiment, a type of Non-MDS code with repair degree d=2 over F₂ can be constructed as follows: If the system is designed to tolerate C=2^{r-1}−1 nodes failure, r is determined once C is specified; then a file (or a portion of file) of size M is divided into k=k′r sub-blocks o_{1,1}, . . . o_{1,r}, o_{2,1}, . . . , o_{2,r}, o_{k,1}, . . . , o_{k′,r}; next the k sub-blocks of information are linearly encoded into n=k′(2^{r}−1) coded blocks over F₂, denoted as z₁, z₂, . . . , zₙ, with each coded block being stored at a unique physical node; and, finally, all the n coded blocks, where n=k′·(2^{r}−1), in the system are constructed as follows:

$${z}_{j} = ( \begin{matrix}{α}_{j , 1} & {α}_{j , 2} & … & {α}_{j , r}\end{matrix} ) ( \begin{matrix}{o}_{i , 1} \\ {o}_{i , 2} \\ ⋮ \\ {o}_{i , r}\end{matrix} ) = {\sum }_{l = 1}^{r} {α}_{j , l} {o}_{i , l} , ( 1 \leq j \leq n ) \qquad ( 1 )$$

where

$$i = ⌊ \frac{j - 1}{{2}^{r} - 1} ⌋ + 1 ,$$

α_{j,l}∈F₂(1≦l≦r), and (α_{j,1} α_{j,2} . . . α_{j,r}) is the binary representation of

$$j - ⌊ \frac{j - 1}{{2}^{r} - 1} ⌋ ( {2}^{r} - 1 )$$

and └ ┘ represents the integer floor. The constructed code has a minimum repair degree d of 2. If a node fails, a newcomer can obtain the lost information in the failed node by only connecting and downloading two coded blocks from two surviving nodes. Such two surviving nodes are called a repair pair. Each node can find at least C repair pairs for repairing it.

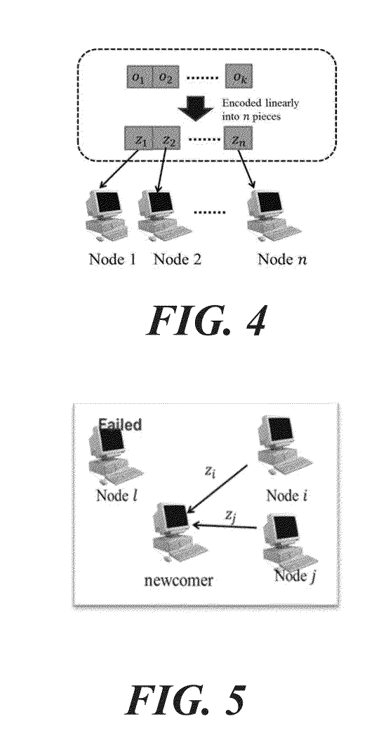

FIGS. 4 and 5 show this model graphically. When node l fails, the newcomer downloads two coded blocks zᵢ and zⱼ from selected node i and j, where zₗ can be recovered from zᵢ and zⱼ. In this system, the newcomer can find C such repair pairs. Thus, it can be seen that Non-MDS code with repair degree d=2 over F₂ has the following features: (a) Due to the encoding over F₂, this coding can be implemented with a XOR operation which is computationally efficient, and the user can decode the original data rapidly after downloading the necessary data; (b) The repair degree is d=2, which means if a node fails, a newcomer can obtain the lost block from the failed node by connecting to only two surviving nodes, such two surviving nodes being called a repair pair; (c) The system can tolerate C nodes of failure, where C is a design parameter; (d) Low update complexity is provided because, if an original block is changed, only C+1 nodes in the system need to be updated (this low update complexity is roughly equivalent to the update complexity of replication); and (e) Every node has at least C repair pairs for repairing it.

In system in accordance with the present embodiment, in order to satisfy the following criteria, n≧k′(2^{r}−1): (1) There must exist k linearly independent coded blocks x₁, x₂, . . . , xₖ selected from z₁, z₂, . . . , zₙ in the system in order to recover o₁, o₂, . . . , oₖ; and (2) Each node can find C=2^{r-1}−1 ways for repairing it. The code in accordance with the present embodiment achieves the above minimum n satisfying the two criteria for the system.

A specific example will now be given for the code in accordance with the present embodiment. Consider a Non-MDS codes with repair degree d=2 over F₂ wherein the original file is divided into k=k′×r=2×3=6 blocks: o_{1,1}, o_{1,2}, o_{1,3}, o_{2,1}, o_{2,2}, o_{2,3}. A set is then provided as set out in Equation 2:

$${A}_{i} = ( \begin{matrix}{α}_{i ( {2}^{r} - 1 ) + 1 , 1} & {α}_{i ( {2}^{r} - 1 ) + 1 , 2} & … & {α}_{i ( {2}^{r} - 1 ) + 1 , r} \\ {α}_{i ( {2}^{r} - 1 ) + 2 , 1} & {α}_{i ( {2}^{r} - 1 ) + 2 , 2} & … & {α}_{i ( {2}^{r} - 1 ) + 2 , r} \\ & ⋮ & & \\ {α}_{( i + 1 ) ( {2}^{r} - 1 ) , 1} & {α}_{( i + 1 ) ( {2}^{r} - 1 ) , 2} & … & {α}_{( i + 1 ) ( {2}^{r} - 1 ) , r}\end{matrix} ) = ( \begin{matrix}1 & 0 & 0 \\ 0 & 1 & 0 \\ 1 & 1 & 0 \\ 0 & 0 & 1 \\ 1 & 0 & 1 \\ 0 & 1 & 1 \\ 1 & 1 & 1\end{matrix} ) \qquad ( 2 )$$

where 0≦i<k′. The n=k′(2^{r}−1)=14 coded blocks in the system are encoded as shown in Equation 3:

$$( \begin{matrix}{z}_{1} \\ {z}_{2} \\ {z}_{3} \\ {z}_{4} \\ {z}_{5} \\ {z}_{6} \\ {z}_{7}\end{matrix} ) = {A}_{0} ( \begin{matrix}{o}_{1 , 1} \\ {o}_{1 , 2} \\ {o}_{1 , 3}\end{matrix} ) , ( \begin{matrix}{z}_{8} \\ {z}_{9} \\ {z}_{10} \\ {z}_{11} \\ {z}_{12} \\ {z}_{13} \\ {z}_{14}\end{matrix} ) = {A}_{1} ( \begin{matrix}{o}_{2 , 1} \\ {o}_{2 , 2} \\ {o}_{2 , 3}\end{matrix} ) \qquad ( 3 )$$

In accordance with this system, one code failure can be repaired by connecting to two surviving nodes and the number of repair pairs is C=2³⁻¹−1=3. For example, if z₁ is lost, it can be repaired by using (z₂, z₃), (z₄, z₅) or (z₆, z₇). Table 3 summarizes the repair pairs for all possible failures:

TABLE 3

| | 1^{st} Repair Pair | 2^{nd} Repair Pair | 3^{rd} Repair Pair |
|---|---|---|---|
| z₁ | (z₂, z₃) | (z₄, z₅) | (z₆, z₇) |
| z₂ | (z₁, z₃) | (z₄, z₆) | (z₅, z₇) |
| z₃ | (z₁, z₂) | (z₅, z₆) | (z₄, z₇) |
| z₄ | (z₁, z₅) | (z₂, z₆) | (z₃, z₇) |
| z₅ | (z₁, z₄) | (z₃, z₆) | (z₂, z₇) |
| z₆ | (z₂, z₄) | (z₃, z₅) | (z₁, z₇) |
| z₇ | (z₁, z₆) | (z₂, z₅) | (z₃, z₄) |

In regards to codes for the present embodiment, we compare replication, Reed-Solomon codes, Exact Minimum Storage Regenerating Codes (E-MSR), and self-repairing codes from four aspects: (1) Update complexity; (2) Complexity for retrieving the original data; (3) Storage efficiency; (4) Repair bandwidth

In accordance with the present embodiment, when an original block needs to be changed, advantageously only C+1 nodes in the system need to be modified. This update complexity of the proposed codes is the same as replication. Reed-Solomon codes and E-MSR without systematic codes both need to update all the nodes in the system. E-MSR with systematic codes needs to update n−k+1 nodes in the system, while self-repairing codes need to update 2C+1 codes in the system.

In accordance with the present embodiment, when a user wants to retrieve the original k sub-blocks and the systematic coded blocks x_{1,1}, . . . , x_{1,r}, x_{2,1}, . . . , x_{2,r}, x_{k′,1}, . . . , x_{k′,r} are available, the user can download the original k blocks directly; if the systematic coded blocks are not available, decoding to retrieve the original data can be very fast due to the computational efficiency of XOR operation.

Replication can download the k original data sub-blocks directly. Reed-Solomon codes, regenerating codes without systematic codes, and self-repairing codes however need to perform a decoding operation over a field whose size is larger than 2, making them unfit for the case where users want to retrieve the original data in a real-time manner. For regenerating codes with systematic codes in the system, when the user wants to retrieve the original data, downloading efficiency is similar to the present embodiment when the systematic codes are available.

Further, for replication, self-repairing codes and the present embodiment, the user must choose k nodes selectively to retrieve the original data, while Reed-Solomon codes and regenerating codes allow selection of an arbitrary k nodes in the system.

If the system can tolerate C=2^{r-1}−1 node failures, operation in accordance with the present embodiment and self-repairing codes need to store

$$\frac{{2}^{r} - 1}{r}$$

times of the original data. Replication needs to store 2^{r-1}−1 times of the original data. Reed-Solomon codes and regenerating codes need to store

$$\frac{k + C}{k}$$

times or the original data.

For one node failure, the repair bandwidth for both the present embodiment and self-repairing codes is

$$\frac{2}{k} M ,$$

where M is the size of the data block that the encoding scheme is applied to. The repair bandwidth for replication is

$$\frac{M}{k} .$$

Reed-Solomon codes need to download data of size M, while regenerating codes need to download data of size

$$\frac{M}{k} \cdot \frac{d}{d - k + 1} ,$$

where d is the number of nodes connected to complete repair.

For t, (t≧2) node failures, the repair bandwidth of R-S codes, self-repairing codes, E-MSR with n−t≧d, and the present embodiment is t times their respective repair bandwidths. For E-MSR with n−t<d, the repair bandwidth is t·M.

The above comparisons are summarized in Table 4:

TABLE 4

| | | | | | | Repair |
|---|---|---|---|---|---|---|
| | | | Retrieving | | Repair | bandwidth |
| | | Update | the original | Storage | bandwidth | (t node failures, |
| | Field | Complexity | data | Cost (n) | (1 node failure) | t ≧ 2) |
| R-S code | F_{q} | Update all n | Solving a | k + 2^{r-1} + 1 | M | 2M |
| | (q ≧ n + 1) | nodes | k × k linear | | | |
| E-MSR without systematic codes E-MSR with systematic codes | F_{q}^{*} | Update n − k + 1 nodes | equation over F_{q} Directly | | $\frac{M \cdot d}{\begin{matrix}k ( d - k + 1 ) \\ ( d \geq 2 k - 2 )\end{matrix}}$ | $\begin{matrix}\frac{t \cdot M \cdot d}{k ( d - k + 1 )} \\ ( if n - t \geq d ) \\ t \cdot M \\ ( if n - 2 < d )\end{matrix}$ |
| Self- repairing code | F_{q}_{^{M/k}} (M/k ≧ k) | Update 2C + 1 nodes | Solving a k × k linear equation | k′(2^{r} − 1) | $2 \frac{M}{k}$ | $\frac{2 \cdot t \cdot M}{k}$ |
| | | | over f_{q} | | | |
| Replication | Nil | Update C + 1 nodes | Directly | k(2^{r-1} − 1) | $\frac{M}{k}$ | $\frac{t \cdot M}{k}$ |
| The present embodiment | F₂ | Update C + 1 nodes | Directly | k′(2^{r} − 1) | $2 \frac{M}{k}$ | $\frac{2 \cdot t \cdot M}{k}$ |

(Note:
*q may be 2k + 3, 2n and n² etc. depending on the specific schemes.)

A specific example of the above comparison is given in Table 5. In this case, we set fault-tolerance ability C=2⁴−1=15 and k=3×5=15. Here, r=5 and k′=3. For E-MSR with systematic codes and E-MSR without systematic codes, we adopt the conventional schemes.

TABLE 5

| | | | | | | Repair |
|---|---|---|---|---|---|---|
| | | | Retrieving | | Repair | bandwidth |
| | | Update | the original | Storage | bandwidth | (t node failures, |
| | Field | Complexity | data | Cost (n) | (1 node failure) | t ≧ 2) |
| R-S code | F₃₂ | Update all the | Solving a | 30 | M | t · M |
| | | nodes in the | 15 × 15 | | | |
| E-MSR without systematic | F₉₀₀ | system | linear equation over F_{q} | | $\frac{M \cdot d}{15 ( d - 14 )}$ | $\frac{t \cdot M \cdot d}{15 ( d - 14 )}$ |
| code* | | | | | | |
| Self-repairing code | F₃₂ | 31 nodes | | 93 | $\frac{2}{15} M$ | $\frac{2 \cdot t}{15} M$ |
| E-MSR with systematic code** | F₃₀ | 16 nodes | Directly | 30 | $\frac{M \cdot d}{15 ( d - 14 )}$ | t · M |
| Replication | Nil | 16 nodes | Directly | 225 | $\frac{1}{15} M$ | $\frac{t}{15} M$ |
| The proposed code | F₂ | 16 nodes | Directly | 93 | $\frac{2}{15} M$ | $\frac{2 \cdot t}{15} M$ |

Note:
*d must be no less than 2k − 2.
**d must be no less than 2k − 1.

To summarize, for an application such as a data centre (e.g., Dropbox™), it is the most important to retrieve the data in a simple way and keep update complexity low as the data will be accessed and updated frequently. In such applications, Reed-Solomon codes, regenerating codes and self-repairing codes fail to satisfy these two requirements. Only replication and non-MDS DSS systems and methods in accordance with the present embodiment are suitable candidates. However, as compared with replication, non-MDS DSS operation in accordance with the present embodiment has much better performance in terms of storage efficiency while providing the same fault-tolerance ability. Higher storage efficiency means that less storage devices and less energy consumption are needed.

### Extended Simplex Code

Now, we propose an extended model of the previous Non-MDS code. The main difference is adding a parity coordinate to the simplex code. The encoding is over [symbol] ₂ (same as previously). The repair degree is d=3. The system can tolerate C nodes of failure. Note that C must be a power of 2. The update complexity is C (same as previously). Every node has at least 2C−1 repair pairs for repairing it.

A type of extended Non-MDS code with repair degree d=3 over [symbol] ₂ can be constructed and described as follows. The system is designed to tolerate C=2²⁻¹ failures, r is determined once C is specified. A file of size M is divided into k=k′r blocks. The k blocks of information are linearly encoded into n=k′2^{r} coded blocks over [symbol] ₂. The generator matrix Eᵢ of the extended code can be described in terms of the generator matrix of the previous case Aᵢ as shown in Equation 4:

$${E}_{i} = ( \begin{matrix}{A}_{i} & 1 \\ 0 & 1\end{matrix} ) = ( \begin{matrix}1 & 0 & 0 & 1 \\ 0 & 1 & 0 & 1 \\ 1 & 1 & 0 & 1 \\ 0 & 0 & 1 & 1 \\ 1 & 0 & 1 & 1 \\ 0 & 1 & 1 & 1 \\ 1 & 1 & 1 & 1 \\ 0 & 0 & 0 & 1\end{matrix} ) \qquad ( 4 )$$

You just add the all-one column 1 and the row all-zeros 0 except the last one. After adding this rows/columns you should make columns operations to be sure that identity matrix is a sub matrix of Eᵢ in order to create a systematic code. This can be done through Gaussian elimination over columns as shown in Equation 5:

$$( \begin{matrix}1 & 0 & 0 & 1 \\ 0 & 1 & 0 & 1 \\ 1 & 1 & 0 & 1 \\ 0 & 0 & 1 & 1 \\ 1 & 0 & 1 & 1 \\ 0 & 1 & 1 & 1 \\ 1 & 1 & 1 & 1 \\ 0 & 0 & 0 & 1\end{matrix} ) - \to ( \begin{matrix}1 & 0 & 0 & 0 \\ 0 & 1 & 0 & 0 \\ 1 & 1 & 0 & 0 \\ 0 & 0 & 1 & 0 \\ 1 & 0 & 1 & 1 \\ 0 & 1 & 1 & 1 \\ 1 & 1 & 1 & 1 \\ 0 & 0 & 0 & 1\end{matrix} ) \qquad ( 5 )$$

The code has repair degree d=3. Each node can find at least 2^{r}−1 repair triples. Consider a non-MDS code with repair degree d=3 over [symbol] ₂ as follows: the original file is divided into k=k′r=2·4=8. You can write the same as the previous case but now the matrix is shown in Equation 6:

$$( \begin{matrix}1 & 0 & 0 & 0 \\ 0 & 1 & 0 & 0 \\ 1 & 1 & 0 & 0 \\ 0 & 0 & 1 & 0 \\ 1 & 0 & 1 & 1 \\ 0 & 1 & 1 & 1 \\ 1 & 1 & 1 & 1 \\ 0 & 0 & 0 & 1\end{matrix} ) \qquad ( 6 )$$

The n=k′2^{r}=2·8=16. Then, the encoding is to encode 4 information coordinates into 8 as shown in Equation 7:

$$( \begin{matrix}{z}_{1} \\ {z}_{2} \\ {z}_{3} \\ {z}_{4} \\ {z}_{5} \\ {z}_{6} \\ {z}_{7} \\ {z}_{8}\end{matrix} ) = {E}_{0} ( \begin{matrix}{o}_{1 , 1} \\ {o}_{1 , 2} \\ {o}_{1 , 3} \\ {o}_{1 , 4}\end{matrix} ) , ( \begin{matrix}{z}_{9} \\ {z}_{10} \\ {z}_{11} \\ {z}_{12} \\ {z}_{13} \\ {z}_{14} \\ {z}_{15} \\ {z}_{16}\end{matrix} ) = {E}_{1} ( \begin{matrix}{o}_{2 , 1} \\ {o}_{2 , 2} \\ {o}_{2 , 3} \\ {o}_{2 , 4}\end{matrix} ) \qquad ( 7 )$$

In this system, one failure can be repaired by connecting three surviving nodes and the available number of such repair triples is 2³−1=7. For example, if z₁ is lost, it can be repaired by using (z₄,z₅,z₈),(z₂,z₃,z₄),(z₂,z₇,z₈),(z₃,z₅,z₇),(z₂,z₅,z₆),(z₄,z₆,z₇) or (z₃,z₆,z₈). The repair triples for all nodes are summarized in Table 6.

TABLE 6

| | 1^{st} | 2^{nd} | 3^{rd} | 4^{th} | 5^{th} | 6^{th} | 7^{th} |
|---|---|---|---|---|---|---|---|
| | repair triple | repair triple | repair triple | repair triple | repair triple | repair triple | repair triple |
| Z₁ | Z₄, Z₅, Z₈ | Z₂, Z₃, Z₄ | Z₂, Z₇, Z₈ | Z₃, Z₅, Z₇ | Z₂, Z₅, Z₆ | Z₄, Z₆, Z₇ | Z₃, Z₆, Z₈ |
| Z₂ | Z₁, Z₃, Z₄ | Z₃, Z₆, Z₇ | Z₁, Z₇, Z₈ | Z₄, Z₅, Z₇ | Z₃, Z₅, Z₈ | Z₁, Z₅, Z₆ | Z₄, Z₆, Z₈ |
| Z₃ | Z₁, Z₂, Z₄ | Z₃, Z₆, Z₇ | Z₁, Z₅, Z₇ | Z₂, Z₅, Z₈ | Z₄, Z₇, Z₈ | Z₁, Z₆, Z₈ | Z₄, Z₅, Z₆ |
| Z₄ | Z₁, Z₅, Z₈ | Z₁, Z₂, Z₃ | Z₂, Z₅, Z₇ | Z₃, Z₇, Z₈ | Z₃, Z₇, Z₈ | Z₂, Z₆, Z₈ | Z₃, Z₅, Z₆ |
| Z₅ | Z₁, Z₄, Z₈ | Z₃, Z₄, Z₆ | Z₁, Z₃, Z₇ | Z₂, Z₄, Z₇ | Z₂, Z₃, Z₈ | Z₁, Z₂, Z₆ | Z₆, Z₇, Z₈ |
| Z₆ | Z₁, Z₃, Z₈ | Z₁, Z₂, Z₅ | Z₁, Z₄, Z₇ | Z₅, Z₇, Z₈ | Z₂, Z₄, Z₈ | Z₃, Z₄, Z₅ | Z₂, Z₃, Z₇ |
| Z₇ | Z₁, Z₃, Z₅ | Z₂, Z₃, Z₆ | Z₁, Z₄, Z₆ | Z₂, Z₄, Z₅ | Z₁, Z₂, Z₈ | Z₃, Z₄, Z₈ | Z₅, Z₆, Z₈ |
| Z₈ | Z₁, Z₂, Z₇ | Z₁, Z₄, Z₅ | Z₁, Z₃, Z₆ | Z₃, Z₄, Z₇ | Z₂, Z₄, Z₆ | Z₅, Z₆, Z₇ | Z₂, Z₃, Z₅ |

The storage efficiency is

$$\frac{{2}^{r}}{r + 1}$$

and Tables 4 and 5 can thus be appended with Table 7 and 8:

TABLE 7

| | | | | | | Repair |
|---|---|---|---|---|---|---|
| | | | | | Repair | bandwidth |
| | | Update | Retrieving | | bandwidth | (t node |
| | | Com- | the original | Storage | (1 node | failures, |
| | Field | plexity | data | Cost (n) | failure) | t ≧ 2) |
| The proposed extended | F₂ | Update C nodes | Directly | k′2^{r} | $3 \frac{M}{k}$ | $3 t \frac{M}{k}$ |
| case | | | | | | |

TABLE 8

| | | | | | | Repair |
|---|---|---|---|---|---|---|
| | | | | | Repair | bandwidth |
| | | Update | Retrieving | | bandwidth | (t node |
| | | Com- | the original | Storage | (1 node | failures, |
| | Field | plexity | data | Cost | failure) | t ≧ 2) |
| The proposed extended | F₂ | 16 nodes | Directly | 96 | $\frac{3}{15} M$ | $\frac{3 t}{15} M$ |
| case | | | | | | |

### Non-Homogeneous Distributed Storage System (DSS)

As discussed above, distributed storage systems (DSS) are widely used today for storing data reliably over long periods of time using a distributed collection of storage nodes which may be individually unreliable. Application scenarios include large data centres and peer-to-peer storage systems that use nodes across the Internet for distributed file storage. One of the challenges for DSS is the repair problem: If a node storing a coded piece fails or leaves the system, we need to create a new encoded piece and store it at a new node in order to maintain the same level of reliability, and we need to do it with a minimum repair bandwidth. To solve this problem, a generic framework based on (n, k, α, d, β) regenerating codes has been introduced in the prior art.

With (n,k) MDS codes, a data file is encoded and distributed to n storage nodes, any k of which can reconstruct the original file. The data file remains intact even though some storage nodes may fail. In case of node failures, we need to regenerate new nodes (called the newcomers) to repair the lost data of the failed nodes. The newcomers are regenerated by downloading some data from the surviving nodes. The required traffic for repairing single-node failure, called repair-bandwidth, is another metric in measuring the system performance, which is essential in bandwidth-limited storage networks.

A class of erasure codes, called regenerating codes, was introduced to reduce the repair-bandwidth of failure nodes. Two novel coding schemes have been proposed and named as minimum storage regenerating (MSR) code and minimum bandwidth regenerating (MBR) code which correspond to the best storage efficiency and the minimum repair bandwidth, respectively.

However, they assume that each node in the DSS is the same such as storage capacity, reliability and communication bandwidth etc. This assumption does not exploit the heterogeneous characteristic of the real world actual systems. In practice, there can be many storage nodes located at different geography location with different connection bandwidth and reliability issues. In such scenario, we may not need to store information on all the nodes, rather to select a few nodes that have the best connection (or some other criteria) to perform the distributed storage.

Moreover, in traditional homogeneous DSS, data are encoded into n blocks, and we store all the n blocks at n different nodes. However in many cases, we would prefer to have many distributed nodes for easy management, we do require a smaller number of storage nodes with large bandwidth. We study how to make use of existing MSR codes to apply in such systems.

We investigate how to apply any (n,k) MSR codes, and store them flexibly in a non-homogenous distributed storage system. We show that by allocating the storage across different nodes efficiently, we can lead to lower download time, higher availability, lower repair bandwidth when all the storage nodes have different parameters or characteristics. Depending on the storage nodes characteristics, we propose three data allocate schemes, namely super-node, partial-homogeneous and minimum-spread. These schemes exploit the different in bandwidth and availability of storage nodes to allocate data efficiently. Since when a node fails in non-homogenous DSS, it corresponds to multi-node failures in homogeneous DSS, it is a challenging task to repair such multi failures with minimum repair bandwidth. In one aspect, we propose a solution for this repair problem and shows that on general, non-homogenous DSS require less complexity and repair bandwidth than the traditional homogeneous DSS.

Additional aspects of the super-node non-homogeneous DSS, also proposes two schemes for storing data using a (k+2, k) maximum distance separable (MDS) codes. These new schemes can achieve optimal repair bandwidth

$$\frac{k + 1}{2} \frac{M}{k}$$

at smaller finite field q and 4 times smaller fragment M than conventional DSS. Smaller M and q help the non-homogeneous DSS to save update bandwidth more efficiently than traditional DSS. Moreover, one of the schemes can achieve one failure repair bandwidth at

$$\frac{M}{2 k}$$

smaller than optimal bandwidth bounds.

### Model of Traditional Homogeneous DSS

We follow the definition of traditional homogeneous DSS using (n,k,d,α,γ) regenerating codes over finite field F_{q}. This network has n storage nodes and every k nodes suffice to reconstruct all the data. The size of the file to be stored is M and partitioned into k equal blocks f₁, . . . fₖ∈ [symbol] _{q}^{N} where

$$N = \frac{M}{k} .$$

After encoding them into n coded blocks using an (n,k) maximum distance separable (MDS) code, we store them at n nodes.

We define the MDS property of a storage code using the notion of data collectors. A storage code where each node contains worth of storage, has the MDS property if a data collector can reconstruct the original file M by connecting to any k out of n storage nodes.

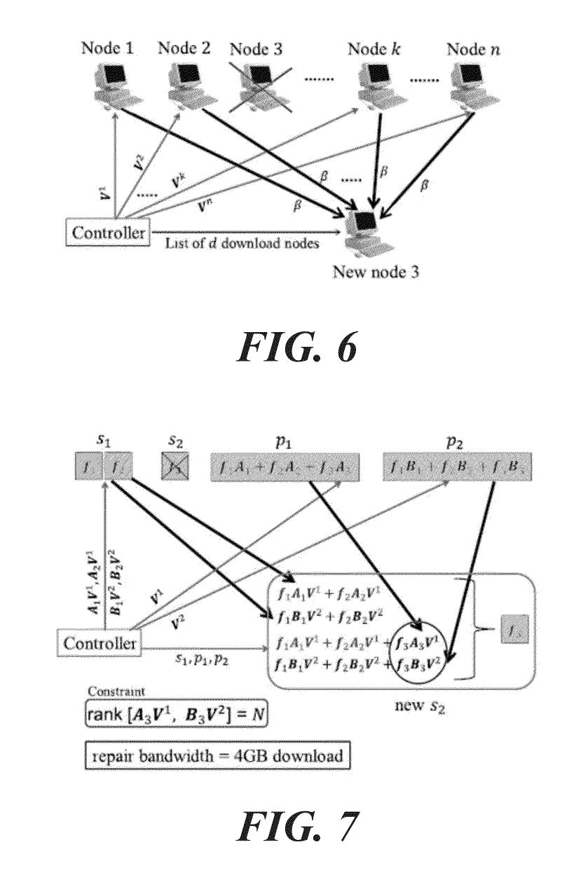

When a node fails, the data stored therein is recovered by downloading β packets each from any d (≧k) of the remaining (n−1) nodes (FIG. 6). Therefore, the total repair bandwidth is γ₁=dβ. The number d of nodes that participate in the repair is named as repair degree. There may be an optimal tradeoff between the storage per node, α, and the bandwidth to repair one node, γ₁. We focus on the extreme point where the smallest

$$α = \frac{M}{k}$$

corresponds to a minimum-storage regenerating (MSR) code as shown in Equation 8:

$$( α , {γ}_{1} ) = ( \frac{M}{k} , \frac{Md}{k ( d - k + 1 )} ) \qquad ( 8 )$$

For such minimum storage systems, two problems arise while repairing failures at the optimal repair bandwidth: there are the requirements of small field size q and the fragment M. If q and M are arbitrarily large, then the constructions are impractical due to the high computation complexity in decoding and the fast growing file size in storing.

Moreover, some conventional systems make the assumption that the same α and β are at each node. The assumption that a DSS should be homogeneous is very restrictive since in practical distributed storage systems, the storage nodes may be stored over the internet with different storage infrastructures and have routes of different capacities between them. The portion of a document delivered by one server should be proportional to its service rate. Thus, a slow server should deliver a small part of the document while a fast server should deliver a large part of the document. Freedom to download different amounts of data from different nodes helps to reduce the net download time and traffic congestion. Such systems will also be highly conducive for load-balancing across the nodes in the network. Therefore, another aspect of the present embodiment is to introduce non-homogeneity in the system and methods of the present embodiment, thereby expanding DSS construction to include non-homogeneous from the current framework of homogeneous distributed storage systems.

To minimize γ₁, let d=n−1 and we get the lower bound for repair bandwidth γ₁ of single-node failure is shown in Equation 9:

$${γ}_{1} = \frac{n - 1}{n - k} \frac{M}{k} \qquad ( 9 )$$

When the number of node failures equals r r≧2, the optimal bound of repair bandwidth of (n,k) MSR codes is shown in Equation 10:

$${γ}_{r} = \frac{r ( d + r - 1 )}{( d + r - k )} \frac{M}{k} \qquad ( 10 )$$

Similarly, to minimize γᵣ, let d=n−r, then the lower bound for repair bandwidth γᵣ of r-node failure is shown in Equation 11:

$${γ}_{r} = \frac{r ( n - 1 )}{( n - k )} \frac{M}{k} \qquad ( 11 )$$

Note that a storage code where each node contains M/k worth of storage has an MDS property if a data collector (DC) can reconstruct the fragment M by connecting to any k out of n storage nodes.

### Model of the Non-Homogeneous DSS

A non-homogeneous DSS with the parameter (n,k,h) is a distributed storage systems with h non-empty nodes based on (n,k) storing codes and the amount of data stored and downloaded from any nodes are variable. Node i in the network stores

$${α}_{i} \geq \frac{M}{k} .$$

When node i fails, the repair bandwidth of node i will be in Equation 12:

$${γ}_{i}^{( i )} = {\sum }_{j ∈ \{ n \} \backslash i}^{ } {β}_{j} \qquad ( 12 )$$

where βⱼ is downloading packets from node j.

In our model, we assume that there are more number of nodes, and each node has a lot of storage size, hence we consider the case n≧h and αᵢ≧M/k. When n>h, there are more redundant blocks than the storage nodes. The storage process has to decide which node(s) to store more blocks. When

$$n = h , {α}_{i} = \frac{M}{k} , {β}_{j} = β$$

for all i, j≠i, we obtain the traditional homogeneous DSS. It is clear that we must have 0≦βⱼ≦αⱼ for all j≠i since a node cannot transmit more information than it is storing. Different nodes may have different repair bandwidth and repair time.

Let f₁, . . . , fₖ∈ [symbol] _{q}^{N} are k blocks divided from file of size M. After encoding, we receive (n−k) parity blocks p₁, . . . , pₙ₋ₖ∈ [symbol] _{q}^{N} where pⱼ=f₁Aⱼ₁+f₂Aⱼ₂+ . . . +fₖAⱼₖ. Here Aⱼᵢ denote an N×N matrix of coding coefficients defined over finite field F_{q} for all 1≦i≦k and 1≦j≦n−k. Let xᵢ≧0 denote the number of blocks of size N stored at storage node i∈{1, . . . , n}, then the total amount of storage used over all nodes is n blocks in Equation 13:

$${\sum }_{i = 1}^{n} {x}_{i} = n \qquad ( 13 )$$

For any arbitrary (n,k) MDS codes, it can only correct maximum (n−k) failure blocks. Therefore, the maximum blocks stored at each node must be no more than (n−k). If we store beyond that, we will not be able to repair when a node fails as shown in Equation 14:

xᵢ≦n−k (14)

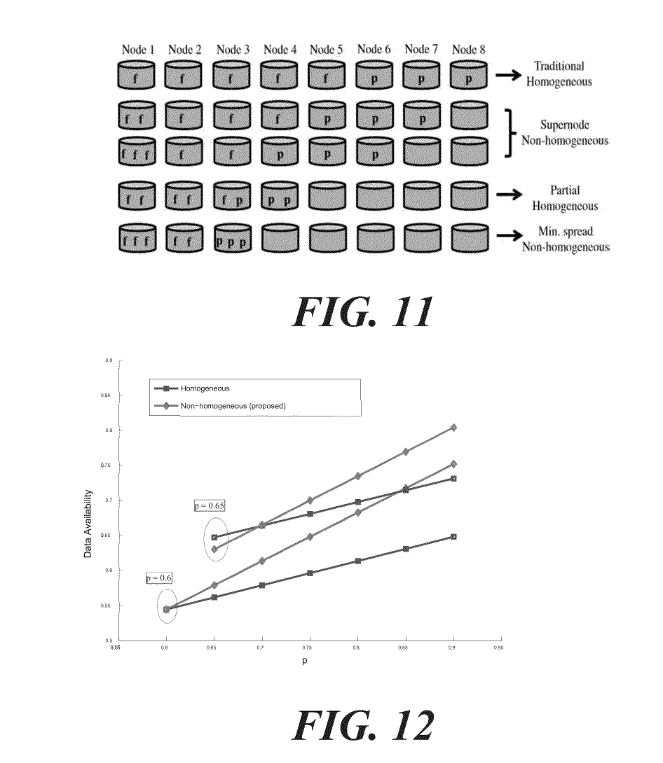

It should be noted that xᵢ=0 means storage node i is an empty node. When (x₁=x_{z}= . . . =x_{b}=1), it becomes the traditional data allocation in (n,k) MSR codes. Consider an example of (n=8,k=5) MDS codes and a data storage system has 8 nodes with different bandwidth and storage capacity. Assume a file of size M=15, then this file is divided into k=5 blocks f₁, . . . , fₖ, each block containing N=M/k=3 packets: fᵢ=[fᵢ₁, . . . , f_{iN}]^{T}. Let pⱼ are parity blocks over finite field F₃ where pⱼ=f₁Aⱼ₁+f₂Aⱼ₂+ . . . +fₖAⱼₖ. FIG. 11 shows four different schemes of data allocation (x₁, . . . , xₙ) named as traditional homogeneous, super-node non-homogeneous, partial-homogeneous, and minimum-spread non-homogeneous. The data allocation of these four schemes corresponds to (1,1,1,1,1,1,1,1), (2,1,1,1,1,1,1,0), (2,2,2,2,0,0,0,0) and (3,2,3,0,0,0,0,0), respectively.

Data Allocation for (n,k) MDS Codes in Non-Homogeneous DSS

We motivate our investigation on data allocation (x₁, x₂, . . . , xₙ) by considering in non-homogeneous DSS. In the following, we consider three different scenarios where a non-homogeneous DSS becomes more efficient than a homogeneous DSS.

Suppose that the download or recovery operation read yᵢ blocks from storage node i (0≦yᵢ≦xᵢ). We associate a weight wᵢ with node i, where wᵢ denotes the cost of downloading one block from node i and without loss of generality, let assume w₁≦w₂≦ . . . ≦wₙ. Our objective is to seek an optimal allocation (x₁, x₂, . . . , xₙ) that minimizes the download cost of k out of n blocks to reconstruct the original file as shown in Equation 15:

$${minimize}_{{y}_{i}} {C}_{d c} = {\sum }_{i ∈ \{ n \}} {w}_{i} {y}_{i} \\ subject to \text{:} \begin{matrix}\sum {y}_{i} \geq k \\ {y}_{i} \leq {x}_{i} \leq n - k\end{matrix} \qquad ( 15 )$$

It can be seen that the download cost C_{dc} increases if we download much data from the high-cost nodes. Therefore, we have to store much data blocks in the low-cost nodes and less data on high-cost nodes. We remind that the possible of maximum blocks stored on each node is (n−k) since we will not be able to repair when a node with more than (n−k) blocks fails. It can be seen that we should allocate (n−k) blocks on the first └k/(n−k)┘ low-cost nodes to minimize C_{dc}. This will lead to the minimum-spread non-homogenous and partial-homogenous model in the next section.

Let [p₁, . . . , pₕ] be the nodes' online probability of h nodes in the (n,k,h) DSS. Let the power set of h, 2^{h}, denote the set of all possible combinations of online nodes. Let A⊂2^{h} represents one of these possible combinations. Then, we will use Q_{A} to represent the event that combination A occurs. Since node availabilities are independent, we have

$$Pr [ {Q}_{A} ] = {\prod }_{i ∈ A} {p}_{i} {\prod }_{j ∈ {2}^{k} \backslash A} ( 1 - {p}_{j} ) \qquad ( 16 )$$

Let Lₖ⊂2^{h} be the subset containing those combinations of available nodes which together store k different redundant blocks as shown in Equation 17:

$${L}_{k} = \{ A \text{:} A ∈ {2}^{h} , {\sum }_{i ∈ A} {x}_{i} \geq k \} \qquad ( 17 )$$

Since the retrieval process needs to download k different blocks out of the total n redundant blocks, the probability of successful recovery for an allocation (x₁, x₂, . . . , xₙ) can be measured as Equation 18:

Pᵣ[successful recovery]=Σ_{A∈L}_{ₖ}Pᵣ[A_{A}]

=Σ_{A∈L}_{ₖ}[Π_{i∈A}pᵢΠ_{j∈2}_{^{k}}_{\A}(1−pⱼ)] (18)

The goal of optimal allocation (x₁, x₂, . . . , xₙ) is to achieve the high data availability of original file in the non-homogeneous DSS. It is not hard to show that determining the recovery probability of a given allocation is computationally difficult (NP-hard). In one aspect, we consider some scenarios such as one node is super reliable and the others are the same reliable. This will lead to the super-node non-homogenous model proposed next.

After we decide (x₁, x₂, . . . , xₙ) for allocation either minimize download cost or maximize availability, we should also consider optimal repair bandwidth for failure node. When node i fails, the repair bandwidth of node i will be Equation 19:

$${γ}_{1}^{( i )} = {\sum }_{j ∈ \{ n \} \backslash i} {β}_{j} \qquad ( 19 )$$

where βⱼ is downloading packets from node j.

In homogeneous DSS, one block is stored in one node. Hence single-node failure corresponds to single block lost. In non-homogeneous DSS, more than one blocks are stored in single node. Therefore, node i failure corresponds to multi-block xᵢ lost. Our objective is to seek an optimal allocation (x₁, x₂, . . . , xₙ) that minimizes the repair bandwidth of node i as shown in Equation 20:

$${minimize}_{{y}_{i }} {γ}_{1}^{( i )} \\ subject to \text{:} {γ}_{1}^{( i )} \leq \frac{( n - 1 )}{( n - k )} {x}_{i} \qquad ( 20 )$$

The present embodiment presents a flexible framework of distributed storage systems named super-node non-homogeneous DSS. Super-node represents a storage node that has higher storage size, or higher communications bandwidth, or higher reliability than other nodes. In a practical system, the super-node may represent the local host, while other storage nodes are located remotely. Three schemes of super-node non-homogeneous DSS based on (k+2, k) MDS and non-MDS codes will be discussed hereinafter (i.e., Schemes A, B and C).

TABLE 9

| | Non-homogenous | | Homogenous |
|---|---|---|---|
| | Proposed scheme | Proposed | Traditional |
| | A and B | scheme C | model |
| S. node | | | |
| s₁ | f₁ f₂ | f₁ | f₁ |
| s₂ | f₃ | f₂ | f₂ |
| . | . | . | . |
| . | . | . | . |
| . | . | . | . |
| sₖ₋₁ | fₖ | fₖ₋₁ | fₖ₋₁ |
| sₖ | x | fₖ | fₖ |
| P. node | | | |
| p₁ | f₁A₁ + . . . + fₖAₖ | f₁A₁ + . . . + fₖAₖ | f₁A₁ + . . . + fₖAₖ |
| | | f₁B₁ + ... + fₖBₖ | |
| p₂ | f₁B₁ + . . . + fₖBₖ | x | f₁B₁ + . . . + fₖBₖ |

Table 9 sets out a comparison of the three schemes of super-node non-homogeneous model versus a traditional homogeneous model based on (k+2, k) MDS codes where S and P are the abbreviations for systematic and parity, respectively. Here, fᵢ∈ [symbol] _{q}^{1+N} and Aᵢ, Bᵢ∈ [symbol] _{q}^{N×N}, for all 1≦i≦k. Note that all of super-node schemes A, B and C use only k+1 storage nodes to store k+2 packets. Note also that schemes A and B both store two systematic data f₁ and f₂ at the same storage node while scheme C stores two parity data at the same storage node. A similar idea can be extended to k+1 or k+2 storage nodes to store k+3 packets, or any further extension. Systems and methods in accordance with these aspects of the present embodiment achieve optimal repair bandwidth

$$\frac{k + 1}{2} \frac{M}{k}$$

at smaller finite field q and 4 times smaller file size M than traditional homogeneous systems. In addition, the relax MDS property of (k+2, k) storage codes allows achievement of smaller repair bandwidths for one failure at

$$\frac{M}{2} < \frac{k + 1}{2} \frac{M}{k} .$$

### Super-Node Scheme A: Store Two Systematic Data at the Same Storage Node (MDS Code).

In discussing a repair of a one-node failure (the case of big node s₁ failing is considered as a two-node failure which will be discussed in more detail later), it is assumed that node s₂ that contains f₃ is failed. For simplicity, the case (n=5, k=3) is initially considered. To recover desired data f₃, the following equations (see Equation 21) are downloaded from two survival parity nodes, where the V¹, V² matrices are based on the failure node. To repair a different node, different V¹, V² are needed which can be pre-calculated and stored in a controller as shown in Equation 21:

f₁A₁V¹+f₂A₂V¹+f₃A₃V¹

f₁B₁V²+f₂B₂V²+f₃B₃V² (21)

where Aᵢ, Bᵢ∈ [symbol] _{q}^{N×N} for all 1≦i≦k and V¹, V²∈ [symbol] _{Q}^{N/}

$$\frac{N}{2}$$

It can be seen that the term (f₁A₁V¹+f₂A₂V¹) and (f₁B₁V²+f₂B₂V²) are removable by downloading (N/2+N/2) packets from big node 1 (See FIG. 7). Therefore, the desired data f₃ can be recovered if the following rank constraint is satisfied in Equation 22:

rank[A₃V¹,B₃V²]=N (22)

For general (k+2, k) case, the optimal repair bandwidth of 1 failure will be

$$\frac{k + 1}{2} \frac{M}{k} .$$

To recover the desired data f₃ we have to use Equation 23:

f₁A₁V¹+f₂A₂V¹+F₃A₃V₁+ . . . +fₖAₖV¹

f₁B₁V²+f₂B₂V²+f₃B₃V²+ . . . +fₖBₖV² (23)

Similarly, the terms (f₁A₁V¹+f₂A₂V¹) and (f₁B₁V²+f₂B₂V²) are removable by downloading (N/2+N/2) packets from big node 1. The following condition must be satisfied to achieve the optimal repair bandwidth in Equation 24:

$$rank [ {A}_{3} {V}^{1} , {B}_{3} {V}^{2} ] = N \\ rank [ {A}_{4} {V}^{1} , {B}_{4} {V}^{2} ] = \frac{N}{2} \\ ⋮ \\ rank [ {A}_{k} {V}^{1} , {B}_{k} {V}^{2} ] = \frac{N}{2} \qquad ( 24 )$$

To relax the complexity of the constraints found in Equation 24, we set Aᵢ=I_{N} and V¹=V², then obtain Equation 25:

$$rank [ {B}_{3} {V}^{1} , {V}^{1} ] = N \\ rank [ {B}_{4} {V}^{1} , {V}^{1} ] = \frac{N}{2} \\ ⋮ \\ rank [ {B}_{k} {V}^{1} , {V}^{1} ] = \frac{N}{2} \qquad ( 25 )$$

The problem of finding matrix Bᵢ is a problem similar to typical homogeneous DSS. However, in accordance with the present embodiment, only (k−2) equations need to be solved. Therefore, the fragment size and finite field will be smaller M=2^{k-1}k, and q=2k−1. This means that the fragment size is reduced to one-fourth of the traditional homogeneous model. This advantageously allows reduction in the minimum size unit of the storing file and the complexity of computation in the smaller finite field.

In the case where the first parity node p₁ fails, a change of variables is made to obtain a new representation for the code in accordance with the present embodiment such that the first parity p₁ becomes a systematic node in the new representation. The change of variables is made as set out in Equation 26:

$${\sum }_{i = 1}^{k} {f}_{i} = {y}_{3} , {f}_{s} = {y}_{s} for 1 \leq s \neq 3 \leq k \qquad ( 26 )$$

And Equation 26 is solved by replacing f₃ in terms of the yᵢ variables and obtaining Equation 27:

$${f}_{3} = {y}_{3} - {\sum }_{s = 1 , s \neq 3}^{k} {y}_{s} \qquad ( 27 )$$

The problem of repairing a first parity is equivalent to repairing a systematic node y₃ in the new presentation. Note that y₁, y₂ are stored in the same node since they correspond to f₁, f₂. To repair y₃, download is made in accordance with Equation 28:

(−y₁)+(−y₂)+y₃+ . . . +(−yₖ)(B₂−b₃)y₁+(B₁−B₂)y₂+B₂y₃+ . . . +(Bₖ−B₃)yₖ (28)

Again, the V¹, V² matrices need to satisfy the conditions of Equation 28 in order to achieve the optimal repair bandwidth in Equation 29:

$$rank [ {B}_{3} {V}^{1} , {V}^{1} ] = N \\ rank [ ( {B}_{4} - {B}_{3} ) {V}^{1} , {V}^{1} ] = \frac{N}{2} \\ ⋮ \\ rank [ ( {B}_{k} - {B}_{3} ) {V}^{1} , {V}^{1} ] \frac{N}{2} \qquad ( 29 )$$

In the same manner, the code in accordance with the present embodiment is rewritten in a form where the second parity is a systematic node in some presentation, as shown in Equation 30:

$$[ \begin{matrix}{I}_{N} & 0 & 0 & … & 0 \\ 0 & {I}_{N} & 0 & … & 0 \\ 0 & 0 & {I}_{N} & … & 0 \\ ⋮ & ⋮ & ⋮ & ⋮ & ⋮ \\ 0 & 0 & 0 & … & {I}_{N} \\ {I}_{N} & {I}_{N} & {I}_{N} & … & {I}_{N} \\ {B}_{1} & {B}_{2} & {B}_{3} & … & {B}_{k}\end{matrix} ] f = [ \begin{matrix}{I}_{N} & 0 & 0 & … & 0 \\ 0 & {I}_{N} & 0 & … & 0 \\ 0 & 0 & {I}_{N} & … & 0 \\ ⋮ & ⋮ & ⋮ & ⋮ & ⋮ \\ 0 & 0 & 0 & … & {I}_{N} \\ {B}_{1}^{′} & {B}_{2}^{′} & {B}_{3}^{′} & … & {B}_{k}^{′} \\ {I}_{N} & {I}_{N} & {I}_{N} & … & {I}_{N}\end{matrix} ] {f}^{′} \qquad ( 30 )$$

where f′ is a full rank row transformation of f. The repair solution is determined in the same manner as handled above in regards to the first parity repair to achieve the optimal repair bandwidth for the second parity of the code.

### Super-Node Scheme B: Store Two Systematic Data at the Same Storage Node (Non-MDS Code).

Scheme B uses the same model as scheme A. However, we can achieve the repair bandwidth for 1 failure below the optimal bound in this non-homogeneous model if the term f₁A₁V¹+f₂A₂V¹) and (f₁BᵢV²+f₂B₂V²) are the same or if the following constraints are satisfied: A₁V¹=B₁V², A₂V¹=B₂V². The following example is used to present the idea of repairing 1 failure below the optimal bandwidth bound for the simple case k=3, n=5. Consider f₁=[a₁,a₂]^{T}, f₂=[b₁,b₂]^{T}, f₃=[c₁,c₂]^{T} and p₁=f₁A₁+f₂A₂+f₃A₃, p₂=f₁B₁+f₂B₂+f₃B₃ are the systematic and parity data of a (5,3) storage code over a finite field F₃ in Equation 31:

$${A}_{1} = [ \begin{matrix}2 & 0 \\ 2 & 1\end{matrix} ] , {A}_{2} = [ \begin{matrix}1 & 2 \\ 0 & 2\end{matrix} ] , {A}_{3} = [ \begin{matrix}2 & 0 \\ 1 & 2\end{matrix} ] , \\ {B}_{1} = [ \begin{matrix}2 & 0 \\ 1 & 2\end{matrix} ] , {B}_{2} = [ \begin{matrix}1 & 1 \\ 2 & 1\end{matrix} ] , {B}_{3} = [ \begin{matrix}1 & 1 \\ 0 & 1\end{matrix} ] . \qquad ( 31 )$$

It can be seen that any single failure (systematic or parity node) except the big node can be repaired with a bandwidth below the optimal bound

$$\frac{k + 1}{2} \frac{M}{k} .$$

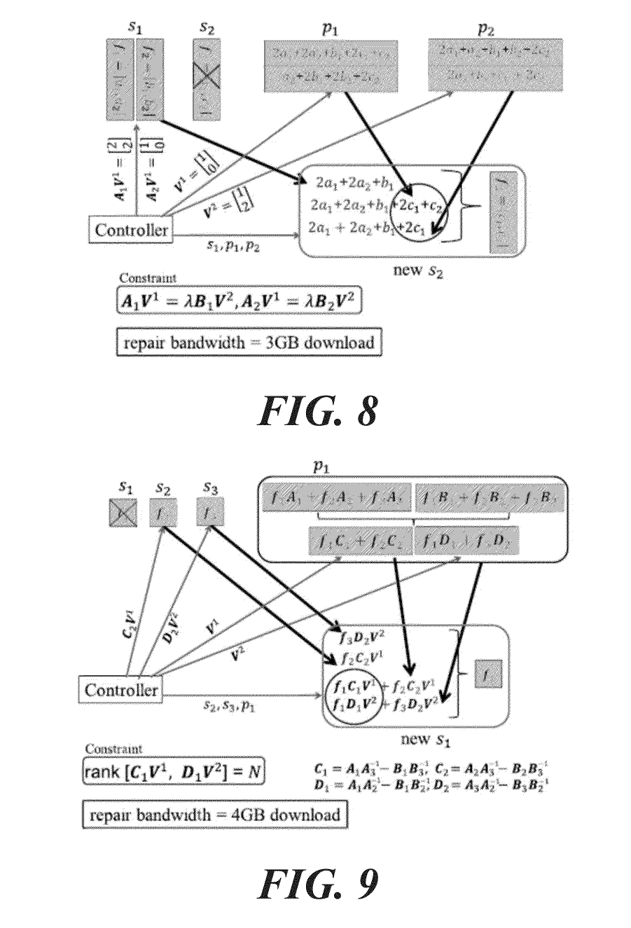

FIG. 8 shows the process of using 2 projection vectors in Equation 32:

$${V}_{1} = [ \begin{matrix}1 \\ 0\end{matrix} ] , {V}_{2} = [ \begin{matrix}1 \\ 2\end{matrix} ] \qquad ( 32 )$$

for repairing 1 systematic failure below the optimal bandwidth bound. It is straightforward for the general case (k+2, k). Therefore, the solution for scheme B can be found in a manner similar to scheme A. However, in scheme B the MDS property of the storage code is not kept since reconstruction of the original information from existing nodes cannot be made if the big node or 2 small nodes fail.

### Super-node Scheme C: Store Two Parity Data at the Same Storage Node (MDS Code).

Similar to scheme A, we first consider the case where n=5, k=3 for simplicity. Without loss of generality, assume that node 1 is failed and 2 parity packets p₁, p₂ are stored at the same parity node. To recover f₁, Equation 33 is followed after eliminating f₂ and f₃ from the parity node:

$$\{ \begin{matrix}{f}_{1} {A}_{1} {V}^{1} + {f}_{2} {A}_{2} {V}^{1} + {f}_{3} {A}_{3} {V}^{1} \\ {f}_{1} {B}_{1} {V}^{2} + {f}_{2} {B}_{2} {V}^{2} + {f}_{3} {B}_{3} {V}^{2}\end{matrix} \{ \begin{matrix}{f}_{1} {C}_{1} {V}^{1} + {f}_{2} {C}_{2} {V}^{1} \\ {f}_{1} {D}_{1} {V}^{2} + {f}_{3} {D}_{2} {V}^{2}\end{matrix} \qquad ( 33 )$$

where Cᵢ, Dᵢ∈F_{q}^{N/N} for i=1, 2 and C₁=A₁A₃⁻¹−B₁B₃⁻¹, C₂=A₂A₃⁻¹−B₂B₃⁻¹, D₁=A₁A₂⁻¹−B₁B₂⁻¹, and D₂=A₃A₂⁻¹−B₃B₂⁻¹. It can be seen that the term f₂C₂V¹ and f₃D₂V² are removable by downloading (N/2+N/2) packets from the parity node (See FIG. 9). Therefore, the desired data f₁ can be recovered if the following rank constraint is satisfied in Equation 34:

tank[C₁V₁,D₁V₂]=N (34)

For a general (k+2, k) case, we set Aᵢ=I_{N} for all i≦N (similar to scheme A). To recover the desired data f₁, the Equation 35 is reduced from the parity node:

f₁(B₁−B₂)+f₂(B₂−B₃)+f₄(B₄−B₃)+ . . . +Fₖ(Bₖ−B₃)

f₁(B₁−B₂)+f₃(B₃−B₂)+f₄(B₄−B₂)+ . . . +Fₖ(Bₖ−B₂) (35)

The condition of Equation 36 must be satisfied to achieve the optimal repair bandwidth

$$\frac{k + 1}{2} \frac{M}{k} :$$

$$rank [ ( {B}_{1} - {B}_{2} ) {V}^{1} , ( {B}_{1} - {B}_{3} ) {V}^{2} ] = N \\ rank [ ( {B}_{4} - {B}_{2} ) {V}^{1} , ( {B}_{4} - {B}_{2} ) {V}^{2} ] = \frac{N}{2} \\ ⋮ \\ rank [ ( {B}_{k} - {B}_{2} ) {V}^{1} , ( {B}_{k} - {B}_{3} ) {V}^{2} ] = \frac{N}{2} \qquad ( 36 )$$

Repair 2 failures for Super-node Schemes A and C

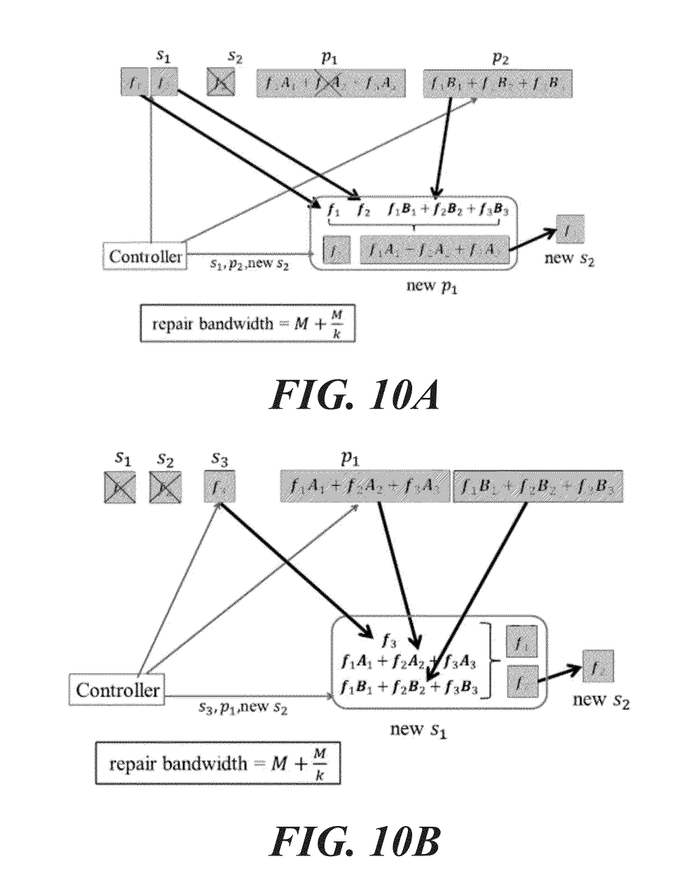

It is trivial to repair the big node s₁ at the repair bandwidth of M by fully downloading data from survival nodes. To repair two small node failures at the optimal repair bandwidth, one solution is shown in FIGS. 10A and 10B. For scheme A, download the k packet from the survival nodes; then the original file can be recovered due to the properties of MDS codes. Therefore, the data of nodes s₂ and p₁ can be obtained and stored in new node s₂. Next, the data of failure node p₁ is forwarded to a newcomer node. The total repair bandwidth will be γ₂=M+M/k. The optimal repair bandwidth for 2 failure nodes for scheme C can be achieved in the same manner. It should be noted that the failure of 1 big node and 1 small node cannot be repaired since it can be regarded as 3 single-node failure nodes, which is beyond the correcting ability of (k+2, k) MDS codes.

TABLE 10

| | Scheme A&C | Scheme B | Alex [1] | Perm. code [5] | Tamo [13] | C.R.C. [9] |
|---|---|---|---|---|---|---|
| | M = 2^{k-1}k | M = 2^{k-1}k | M = 2^{k+1}k | M = 2^{k}k | M = 2^{k}k | M = 2k |
| | q ≧ 2k − 1 | q ≧ 2k − 1 | q ≧ 2k + 3 | q ≧ 2k + 1 | q ≧ 2k + 1 | q ≧ n |
| 1 failure | $γ = \frac{M}{k} \frac{k + 1}{2}$ | $γ = \frac{M}{2}$ | $γ = \frac{M}{k} \frac{k + 1}{2}$ | $\frac{M}{k} \frac{k + 1}{2}$ | $γ = \frac{M}{k} \frac{k + 1}{2}$ | N.A |
| 2 failures | $γ = M + \frac{M}{k}$ | N.A | $γ = M + \frac{M}{k}$ | $γ = M + \frac{M}{k}$ | $γ = M + \frac{M}{k}$ | $γ = M + \frac{M}{k}$ |

Thus it can be seen that optimal repair bandwidths for 1 failure can be achieved at a smaller finite field q and at a four times smaller fragment size M than conventional schemes. In addition, repairing 1 failure using non-MDS codes can achieve

$$\frac{M}{2 k}$$

smaller bandwidth than the optimal bound. A summary is presented in Table 10 for the present schemes and various conventional technologies.

Using the example n=5, k=3, assume a data file, denoted as FILE, of size 48 GB is needed to store across the distributed storage system. In accordance with schemes A and C, the file is divided into four fragments of size M₁=12. These fragments are stored across k+1=4 nodes in the non-homogeneous DSS. If a small node fails, the repair bandwidth will be

$$4 \times \frac{{M}_{1}}{k} \frac{k + 1}{2} = 32 GB .$$

If two failure nodes occur, the repair bandwidth will be

$$4 \times ( {M}_{1} + \frac{{M}_{1}}{k} ) = 64 GB .$$

To update one fragment M₁ of the file, the update bandwidth will be

$$\frac{{M}_{1}}{k} n = 20 GB .$$

The same results are achieved for both schemes A and C in repairing failures and updating information. In regards to scheme B, the file is divided into four fragments of size M₁=12 (similar to the division in regards to schemes A and C). If a small node fails, the repair bandwidth will be

$$4 \times \frac{{M}_{1}}{2} = 24 GB .$$

To update one fragment M₁ of the file, the update bandwidth will be

$$\frac{{M}_{1}}{k} n = 20 GB .$$

TABLE 11

| | Scheme A&C | Scheme B | Alex [1] | Perm. code [5] | Tamo [13] | C.R.C. [9] |
|---|---|---|---|---|---|---|
| | M₁ = 12 | M₁ = 12 | M₂ = 48 | M₃ = 24 | M₄ = 24 | M₅ = 6 |
| 1 failure | q ≧ 5 | q ≧ 5 | q ≧ 9 | q ≧ 7 | q ≧ 7 | q ≧ 5 |
| 2 failures | γ = 32 | γ = 24 | γ = 32 | γ = 32 | γ = 32 | N.A |
| update | γ = 64 | N.A | γ = 64 | γ = 64 | γ = 64 | γ = 64 |
| ≦12 GB data | δ = 20 | δ = 20 | δ = 80 | δ = 40 | δ = 40 | δ = 10 |

In regards to a first conventional system (denoted in Tables 10 and 11 as Alex), the file is divided into one fragment of size M₂=48 such as FILE=M₂. The repair bandwidth of one failure node for this systems is, therefore,

$$1 \times ( \frac{{M}_{2}}{k} \frac{k + 1}{2} ) = 32 GB$$

and for two failure nodes

$$1 \times ( {M}_{2} + \frac{{M}_{2}}{k} ) = 64 GB$$

is required. The update bandwidth for one fragment M₂ will be

$$\frac{{M}_{2}}{k} n = 80 GB .$$

The repair and update bandwidth for other conventional methods are computed in a similar manner and shown in Table 11. Note that the C.R.C. method cannot repair one failure with optimal bandwidth. All of the methods require similar bandwidth for repairing failures except scheme B. Moreover, schemes A, B and C have advantages in updating small parts of the file as compared with the conventional methods (except the C.R.C. method). The C.R.C. method, however, is not practical since it cannot achieve the optimal repair bandwidth in the case of 1 failure node. Permutation method and MDS array method are also impractical since they can only repair the systematic nodes.

Thus, the non-homogeneous DSS in accordance with the present embodiment provides a flexible framework for distributed storage systems. Two schemes of storing data using a (k+2, k) MDS codes can achieve optimal repair bandwidth (k+1)/2·M/k at smaller finite field q and a four times smaller fragment M than prior art systems. The smaller M and q also help the non-homogeneous DSS to save update bandwidth more efficiently than traditional methods. Moreover, scheme B can achieve one failure repair bandwidth at

$$\frac{M}{2 k}$$

smaller than the optimal bandwidth bound.

### Numerical Case Study

To compare the data availability, we examine a scenario of node online probability where the online probability of super-node is greater than the other node p₁≧p₂=p₃= . . . =pₙ=p.

The data availability of homogeneous Prₕₒₘₒ and non-homogeneous Prd DSS can be computed by Equation 37 and 38:

$$\begin{matrix}{Pr}_{homo} = {p}^{k + 1} + ( k + 1 ) ( 1 - p ) {p}^{k} + \frac{k ( k + 1 )}{2} {{p}_{1} ( 1 - p )}^{2} {p}^{k - 1} & ( 37 ) \\ {Pr}_{non \text{-} homo} = {p}^{k} + {kp}_{1} ( 1 - p ) {p}^{k - 1} + \frac{k ( k + 1 )}{2} {{p}_{1} ( 1 - p )}^{2} {p}^{k - 2} & ( 38 )\end{matrix}$$

Let p₁=χp where χ≧1. The condition Prₙₒₙ₋ₕₒₘₒ≧Prₕₒₘₒ will induce) χ≧p/(p−½(1−p)[(k−1)−(k+1)p]). It can be seen that if

$$p \leq \frac{k - 1}{k + 1} ,$$

then p/(p+½(1−p)[(k−1)−(k+1)p])≦1≦χ. Therefore, Prₙₒₙ₋ₕₒₘₒ≧Prₕₒₘₒ for all

$$p \leq \frac{k - 1}{k + 1} .$$

We run the simulations for the case of k=4, p=0.6 and p=0.65 and obtain the result in FIG. 12. It can be seen that for

$$p = \frac{k - 1}{k + 1} = 0.6 ,$$

data availability of non-homogeneous DSS scheme outperforms the homogeneous DSS scheme. For

$$p = 0.65 > \frac{k - 1}{k + 1} ,$$

the non-homogeneous schemes also have a big improvement when p₁ has a high online availability. Therefore, it can be seen that our proposed non-homogeneous DSS schemes achieve a higher data availability than the traditional homogeneous DSS. The gap between the two becomes larger when the online availability of the super node increases, e.g. when p₁ is greater than 25% of p, the data availability of the proposed non-homogenous over homogenous DSS is increased by 10%.

### Partial-Homogeneous DSS

In this scheme, all nonzero nodes store the same blocks of information. The data allocation (x₁, x₂, . . . , xₙ) of this scheme corresponds to Equation 39:

$$\{ \begin{matrix}{x}_{1} = {x}_{2} = … = {x}_{h} = \frac{n}{h} \\ while 1 \leq \frac{n}{h} \leq n - k\end{matrix} \qquad ( 39 )$$

In traditional homogeneous, the intuitive approach of spreading n blocks maximally over n nodes, i.e., assigning xᵢ=1 for all 1≦i≦n, turns out to be optimal. In the non-homogeneous, the optimal allocation may not be maximal spread. For maximum reliability and minimum the download cost, we would therefore need to find an optimal allocation x₁. It should be note that this scheme corresponds to the case of storage budget equal to the file size. However, our partial-homogeneous scheme considers how to achieve the optimal repair bandwidth when a node fails. This leads to the requirement of xᵢ strict to integer number for all 1≦i≦n. In order to download cost of original file, we have to download full from low-cost node and total download blocks equal k. The corresponding download cost of original file will be in Equation 40:

$${C}_{dc} = {\sum }_{1 \leq i \leq h - 1} \frac{{w}_{i} n}{h} \qquad ( 40 )$$

In special case n=h (n−k) or x₁=n−k, any single node failure is equivalent to losing (n−k) blocks. Since k=(h−1)(n−k), the new incoming node have to collects k blocks from h−1 nodes to repair any single-node failure

$${γ}_{1}^{( i )} = {\sum }_{1 \leq i \neq i \leq h} ( n - k ) = k .$$

The corresponding download cost of the original file will be in Equation 41

$${C}_{dc} = {\sum }_{1 \leq i \leq h - 1} {w}_{i} ( n - k ) \qquad ( 41 )$$

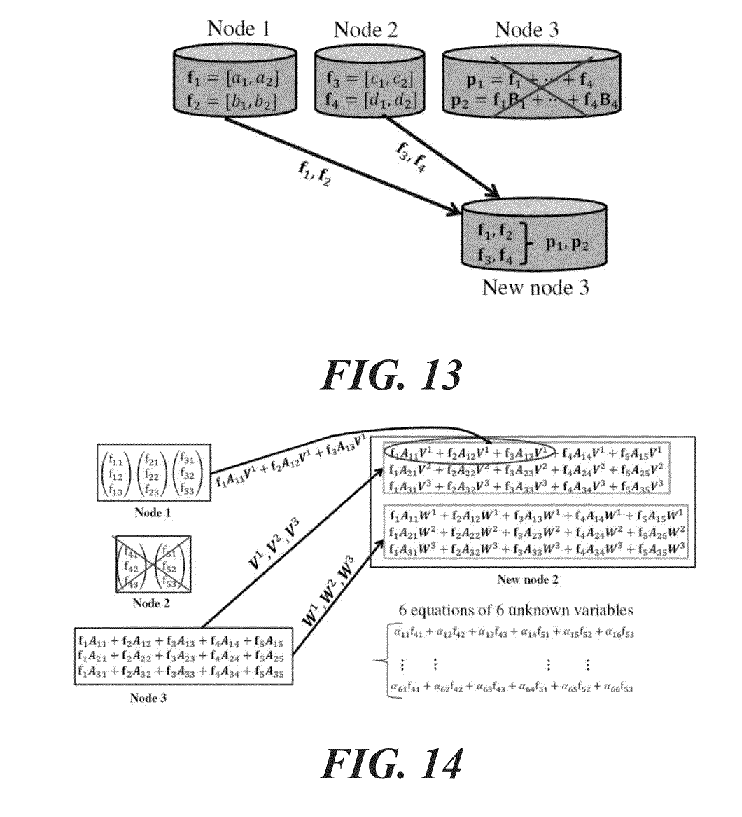

FIG. 13 shows an example of (n=6, k=4, h=3) non-homogeneous DSS using the same (6,4) MDS code in the previous example. In this case, h=3 and we use only 3 nodes to store data (x₁=x₂=x₃=2). To repair the third node failure, we have to download k=4 blocks f₁,f₂,f₃,f₄ from node 1 and node 2. The download cost will be C_{dc}=2W₁+2w₂. It can be seen that repairing failure node in this case is similar to the traditional homogeneous DSS.

### Minimum-Spread Non-Homogeneous DSS

In this scheme, we try to store much possible data on each node. It is named as minimum-spread non-homogeneous since we use minimum number of active nodes than any other schemes. Assume n=(h−1)(n−k)+r where 1≦r<n−k, we have two kind of nodes which store (n−k) blocks and r blocks. Due to information blocks is more important than redundancy blocks, it is recommended that k information blocks should spread on lowest cost nodes and (n−k) parity blocks should stay on the same node with the highest cost. The data allocation (x₁, x₂, . . . , xₙ) of this scheme corresponds to Equation 42:

$$\{ \begin{matrix}{x}_{1} = {x}_{2} = … = {x}_{h - 2} = n - k \\ {x}_{h - 1} = r , {x}_{h} = n - k\end{matrix} \qquad ( 42 )$$

The download cost of original file is optimal and is shown in Equation 43.

$${C}_{dc} = {\sum }_{i = 1}^{h - 2} {w}_{i} ( n - k ) + {w}_{h - 1} r \qquad ( 43 )$$

When a node with (n−k) blocks fails, we have to download k blocks from survival nodes. In the case of repairing failure node of r blocks, interference alignment has been applied to achieve the optimal repair bandwidth of MSR codes by aligning the various interferences independently. Here, we show one possible solution of repair nodes with r blocks by using interference alignment in non-homogeneous DSS.
1. h=2→r=k, then

$$k \leq \frac{n}{2}$$

and k≦n−k (low code rate). The optimal data allocation will be (x₁=n−k, x₂=k). It is trivial to repair any single node, we only have to download k blocks from the survival node.
2. h≧3 and 0<r<n−k, then

$$\frac{n}{2} < k$$

and (n−k)≦k (high code-rate). When node i fails, the optimal repairing process is as follow:
1≦i≦h−2 and i=h, then yⱼ=xⱼ for i≠j, the total of download blocks for repairing node i is k blocks as shown in Equation 44

$${\sum }_{1 \leq j \neq n \leq h} {y}_{j} = ( h - 1 ) ( n - k ) = k \qquad ( 44 )$$

i=h−1, the total of download blocks is depend on the minimum of k and the bound

$$\frac{r ( n - 1 )}{n - k} .$$

The condition

$$\frac{r ( n - 1 )}{n - k} > k$$

corresponds to k²−nk+r(n−1)>0 or

$$k > \frac{h - 1}{h} n .$$

Therefore, when

$$k > \frac{h - 1}{h} n ,$$

we need to download k blocks to repair (h−1)-th node as shown in Equation 45:

$${y}_{j} = \{ \begin{matrix}{x}_{j} , & if 1 \leq j \leq h - 2 \\ r , & if j = h - 1 \\ 0 , & otherwise\end{matrix} \qquad ( 45 )$$

When

$$\frac{n}{2} < k \leq \frac{h - 1}{h} n ,$$

to repair node (h−1) we need to download (h−1)r blocks as shown in Equation 46:

$${y}_{j} = \{ \begin{matrix}r , & if 1 \leq j \leq h - 2 and j = h \\ 0 , & otherwise\end{matrix} \qquad ( 46 )$$

Table 13 summarize the repair bandwidth for any failure node in the minimum-spread model.

### SUMMARY OF REPAIR BANDWITH FOR ANY FAILURE NODE IN THE MINIMUM SPREAD NON-HOMOGENEOUS DSS BASED ON (n,k) MSR CODES WHERE n=(h−1)(n−k)+r

TABLE 13

| | Node | Number of blocks | Min. Spread | Traditional MSR code |
|---|---|---|---|---|
| $h = 2 , k \leq \frac{n}{2}$ | 1 | n − k | k | k |
| | 2 | k | k | k |
| $h \geq 3 , \frac{n}{2} < k \leq \frac{h - 1}{h} n$ | 1, . . . , (h − 2) | n − k | k | k |
| | (h − 1) | r | (h − 1)r | $( h - 1 ) r + \frac{r ( r - 1 )}{n - k} = \frac{r ( n - 1 )}{n - k}$ |
| | h | n − k | k | k |
| $h \geq 3 , k > \frac{h - 1}{h} n$ | 1, . . . , (h − 2) | n − k | k | k |
| | (h − 1) | r | k | k |
| | h | n − k | k | k |

Minimum-Spread Scheme for (k+3, k) MSR Codes

First, consider the case k=5. Assume a file of size M is divided into k=5 blocks f₁, . . . , fₖ, each block containing

$$N = \frac{M}{k}$$

packets: fᵢ=[fᵢ₁, . . . , f_{iN}]^{T}. After encoding them into k+3 encoded blocks, we store them across the distributed storage as below.
The first node stores 3 systematic blocks f₁, f₂, f₃
The second node stores 2 systematic blocks f₄, f₅
The parity node stores 3 redundancy blocks p₁=f₁A₁₁+ . . . +fₖA₁ₖ, p₂=f₁A₂₁+ . . . +fₖA₂ₖ and p₃=f₁A₃₁+ . . . +fₖA₃ₖ.

Here, A₁ᵢ, A₂ᵢ and A₃ᵢ∈F_{q}^{N+N} for all 1≦i≦k. To recover the data block f₁,f₂ in the second node, we have to download the Equations 47 and 48 from the last node:

$$\begin{matrix}\{ \begin{matrix}{f}_{1} {A}_{11} {V}^{1} + {f}_{2} {A}_{12} {V}^{1} + … + {f}_{5} {A}_{15} {V}^{1} \\ {f}_{1} {A}_{21} {V}^{2} + {f}_{2} {A}_{22} {V}^{2} + … + {f}_{5} {A}_{25} {V}^{2} \\ {f}_{1} {A}_{31} {V}^{3} + {f}_{2} {A}_{32} {V}^{3} + … + {f}_{5} {A}_{35} {V}^{3}\end{matrix} & ( 47 ) \\ \{ \begin{matrix}{f}_{1} {A}_{11} {W}^{1} + {f}_{2} {A}_{12} {W}^{1} + … + {f}_{5} {A}_{15} {W}^{1} \\ {f}_{1} {A}_{21} {W}^{2} + {f}_{2} {A}_{22} {W}^{2} + … + {f}_{5} {A}_{25} {W}^{2} \\ {f}_{1} {A}_{31} {W}^{3} + {f}_{2} {A}_{32} {W}^{3} + … + {f}_{5} {A}_{35} {W}^{3}\end{matrix} & ( 48 )\end{matrix}$$

where A

$${A}_{ji} ∈ {ℙ}_{q}^{N \times N} and {V}^{j} , {W}^{j} ∈ {ℙ}_{q}^{N \times \frac{N}{n - k}}$$

for all 1≦i≦k and 1≦j≦n−k. It can be seen from FIG. 14 that the term (f₁Aᵢ₁Vⁱ+f₂Aᵢ₂Vⁱ+f₃Aᵢ₃Vⁱ) and f₁Aᵢ₁Wⁱ+f₂Aᵢ₂Wⁱ+f₃Aᵢ₃Wⁱ) are removable by downloading

$$\frac{N}{n - k} = 1$$

packets from second node. Therefore, the desired data f₄ and f₅ can be recovered by solving Equation 49:

$$\{ \begin{matrix}{f}_{4} {A}_{14} {V}^{1} + {f}_{5} {A}_{15} {V}^{1} \\ {f}_{4} {A}_{24} {V}^{2} + {f}_{5} {A}_{25} {V}^{2} \\ {f}_{4} {A}_{34} {V}^{3} + {f}_{5} {A}_{35} {V}^{3} \\ {f}_{4} {A}_{14} {W}^{1} + {f}_{5} {A}_{15} {W}^{1} \\ {f}_{4} {A}_{24} {W}^{2} + {f}_{5} {A}_{25} {W}^{2} \\ {f}_{4} {A}_{34} {W}^{3} + {f}_{5} {A}_{35} {W}^{3}\end{matrix} \qquad ( 49 )$$

It can be seen that the number of unknown variables and the number of equations in (49) are 2N. Therefore, we can recover the desired data f₄ and f₅ by solving the Equation 49. The repair bandwidth process requires 4N. The repair bandwidth of node 3 will be equivalent to 2 failure nodes in the traditional homogeneous and the bound of repair bandwidth for 2 failures will be

$$γ = 2 \times \frac{( n - 1 )}{( n - k )} \frac{M}{k} = 4 N + \frac{2}{3} N .$$

It can be seen that the minimum-spread non-homogeneous save

$$\frac{2}{n - k} \frac{M}{k}$$

bandwidth than traditional homogeneous DSS.

In the general (n=k+3,k) MSR codes, the repair bandwidth of (n−k)-block node is k blocks while the repair bandwidth of r-block node in minimum-spread non-homogeneous is reduced

$$\frac{r ( r - 1 )}{n - k} \frac{M}{k}$$

by than the traditional homogeneous DSS by applying the same technique as seen in the case of k=5. It can be concluded that minimum-spread non-homogeneous DSS can repair any single node with the optimal repair bandwidth.

### Performance Analysis for Minimum-Spread Non-Homogeneous DSS

As compared with the traditional MSR codes, our scheme can achieve better download cost of original file and smaller repair bandwidth of r-blocks node. Our scheme can reduce r(r−1)/n−k repair bandwidth than traditional MSR codes. A summary is presented in Table 14. It can be seen that our scheme use less storage nodes than the traditional method since each storage node is responsible for storing multiple data blocks. It is often desirable for most practical distributed storage systems where the number of data blocks per node is much greater than one.

### COMPARISON OF MINIMUM SPREAD NON-HOMOGENEOUS MODEL VS. TRADITIONAL MODEL BASED ON (n,k) MDS CODES WHERE n=(h−1)(n−k)+r

TABLE 14

| Scheme | Node | download cost | repair bandwidth |
|---|---|---|---|
| Min. spread Non-homogeneous | h | ${\sum }_{i = 1}^{h - 2} {w}_{i} ( n - k ) + {rw}_{h - 1}$ | γᵣ = (h − 1)r |
| Traditional Homogeneous | n | ${\sum }_{i = 1}^{k} {w}_{i}$ | ${γ}_{r} = \frac{r ( n - 1 )}{n - k}$ |

### Numerical Case Study

To compare the data availability, we examine a scenario of node online probability where the online probability of the first (h−1) nodes equal p₁ and greater than the rest (n−h+1) nodes as shown in Equation 50:

p₁=p₂= . . . =pₕ₋₁≧pₕ=pₕ₊₁= . . . =pₙ=p (50)

The data availability of minimum-spread model Prnon-horno can be computed as

Equation 51.

Prₙₒₙ₋ₕₒₘₒ=p₃^{h-1}+(h−1)pp₁^{h-2}(1−p₁) (51)

Since 0≦p≦p₁<1, it can be seen that Prₙₒₙ₋ₕₒₘₒ becomes smaller when h increases. Therefore, we focus mainly on h=3, 4 and compare with traditional model to show the efficiency of minimum-spread model.

Let begin with h=3, from (50) the first two nodes will have greater online availability than the rest. Therefore, the data availability of traditional model can be computed as below.

$${Pr}_{homo} = {p}_{1}^{2} \{ {\sum }_{r = k - 2}^{n - 2} ( \begin{matrix}r \\ n - 2\end{matrix} ) {{p}^{r} ( 1 - p )}^{n - 2 - r} \} + 2 {p}_{1} ( 1 - {p}_{1} ) \{ {\sum }_{r = k - 1}^{n - 2} ( \begin{matrix}r \\ n - 2\end{matrix} ) {{p}^{r} ( 1 - p )}^{n - 2 - r} \} + {( 1 - {p}_{1} )}^{2} \{ {\sum }_{r = k}^{n - 2} ( \begin{matrix}r \\ n - 2\end{matrix} ) {{p}^{r} ( 1 - p )}^{n - 2 - r} \} \qquad ( 52 )$$

In the case of minimum-spread model n=k+3, (52) becomes Equation 53:

$${Pr}_{homo} = {p}^{k + 1} + ( k + 1 ) {p}^{k} ( 1 - p ) + {p}_{1} k ( k + 1 ) {{p}^{k - 1} ( 1 - p )}^{2} + \frac{k ( k + 1 )}{2} {{p}_{1}^{2} ( 1 - p )}^{2} {p}^{k - 2} ( \frac{k - 1}{3} - p ) \qquad ( 53 )$$

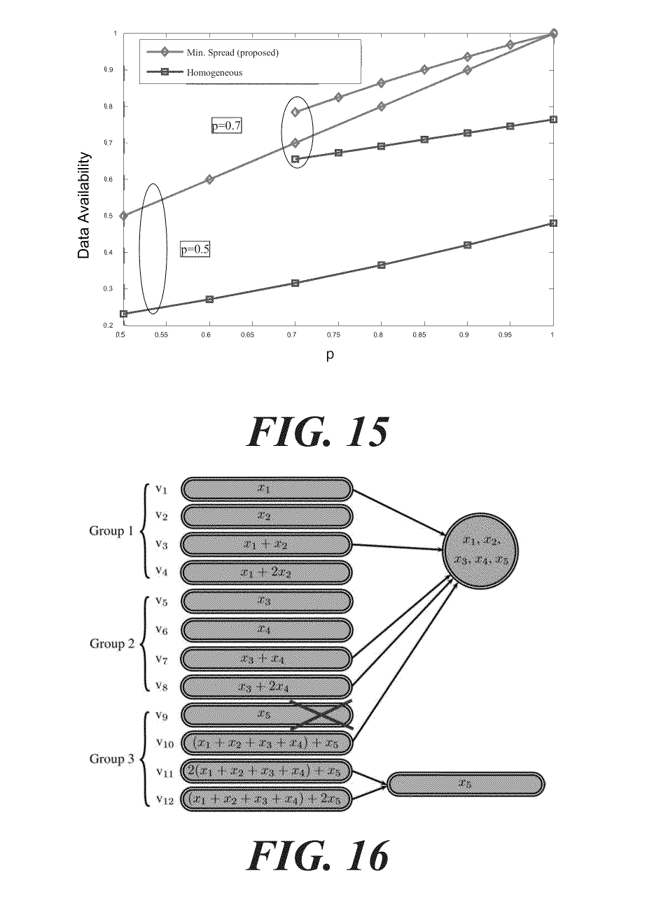

In order to confirm the increase of data availability, we run some simulations on h=3, k=5 and 0.5≦p≦p₁≦1. From FIG. 15, it can be seen that our model can improve the data availability to more than 10% in comparison to the traditional model.

For checking the efficiency of our scheme on minimum download cost and repair bandwidth, some (n,k) MDS codes are used such that h=3, 4 and r=2, 3, . . . , 5. For example, the (n=8, k=5) MSR code in the previous example can be used for the case of (h=3, r=2).

From Table 15, it can be seen that our scheme can achieve a smaller download cost and repair bandwidth than the traditional MSR codes. When r increases, the repair bandwidth can be much smaller than the traditional optimal bandwidth bound, e.g. when r=5, the repair bandwidth of our scheme is reduced more than 20% of the traditional method. However, our scheme cannot repair any concurrent multi-node failures. Therefore, it is a tradeoff between download cost, repair bandwidth and ability of correcting multi-node failures. Our scheme is best fit with any storage systems with only single-node failure.

### COMPARISON OF MINIMUM SPREAD NON-HOMOGENEOUS MODEL VS. TRADITIONAL HOMOGENEOUS MODEL BASED ON (n,k) MSR CODES WHERE n=(k−1)(n−k)+v and w_{γ}≦w_{γ}≦ . . . ≦w_{γ}. SMALLER VALUE OF DOWNLOAD COST AND REPAIR BANDWIDTH MEANS BETTER PERFORMANCE

TABLE 15

| | | | | Allocation | Download cost C_{dc} | | Repair bandwidth γᵣ | |
|---|---|---|---|---|---|---|---|---|
| | n | k | r | (x₁, . . . , xₕ | Non-homo. | Traditional | Non-homo | Traditional |
| h = 3 | 8 | 5 | 2 | (3, 2, 3) | 3w₁ + 2w₂ | w₁ + . . . + w₅ | 4 | 4.67 |
| | 11 | 7 | 3 | (4, 3, 4) | 4w₁ + 3w₂ | w₁ + . . . + w₇ | 6 | 7.50 |
| | 14 | 9 | 4 | (5, 4, 5) | 5w₁ + 4w₂ | w₁ + . . . + w₉ | 8 | 10.40 |
| | 17 | 11 | 5 | (6, 5, 6) | 6w₁ + 5w₂ | w₁ + . . . + w₁₁ | 10 | 13.33 |
| h = 4 | 11 | 8 | 2 | (3, 3, 2, 3) | 3w₁ + 3w₂ + 2w₃ | w₁ + . . . + w₈ | 6 | 6.67 |
| | 15 | 12 | 3 | (4, 4, 3, 4) | 4w₁ + 4w₂ + 3w₃ | w₁ + . . . + w₁₂ | 9 | 10.50 |
| | 19 | 14 | 4 | (5, 5, 4, 5) | 5w₁ + 5w₂ + 4w₃ | w₁ + . . . + w₁₄ | 12 | 14.40 |
| | 23 | 17 | 5 | (6, 6, 5, 6) | 6w₁ + 6w₂ + 5w₃ | w₁ + . . . + w₁₇ | 15 | 18.33 |

Thus it can be seen that three robust and advantageous methodologies related to super-node distributed storage system (DSS) have been provided within two DSS architectures which dynamically select the file fragment size according to the encoding scheme, storage server bandwidth, and file content type. A non-MDS DSS system is provided which has the advantages of: fast and simple encoding over a field of size two, toleration of a maximum of C nodes of failure (where C is a design parameter), repair degree of 2 (i.e. every failed node can be repaired by downloading information from a pair of surviving nodes called a repair pair), C repair pairs for every node, and a low update complexity of C+1 (i.e. whenever a piece of information is being updated, only the storage on C+1 nodes need to be updated). Further, a non-homogenous DSS is provided which has the advantages of: requiring a smaller file fragment (e.g., four times smaller) and a smaller operational field size when use with (k+2, k) MDS code, while maintaining the same optimal repair bandwidth and total storage as other homogenous (k+2, k) DSSs; and achieving a lower repair bandwidth for a 1-failure scenario when relaxing the MDS property. Besides super-node scheme, our minimum-spread scheme can achieve the minimum download cost and require lower repair bandwidth of r-failures by r(r−1)M/(n−k)k than the optimal bandwidth bound in the traditional homogeneous DSS.

### Local Repairable Code DSS

In a distributed storage system, a data file is stored at a distributed collection of storage devices/nodes in a network. Since any storage device is individually unreliable and subject to failure (i.e. erasure), redundancy must be introduced to provide the much-needed system-level protection against data loss due to device/node failure. The simplest form of redundancy is replication. By storing c identical copies of a file at c distributed nodes, one copy per node, a c-replication system can guarantee the data availability as long as no more than (c−1) nodes fail. Such systems are very easy to implement, but extremely inefficient in storage space utilization, incurring tremendous waste in devices and equipment, building space, and cost for powering and cooling. More sophisticated systems employing erasure coding can expect to considerably improve the storage efficiency. Consider a file that is divided into k equal-size fragments. A judiciously-designed [n,k] erasure (systematic) code can be employed to encode the k data fragments (termed systematic symbols in the coding jargon) into n fragments (termed coded symbols) stored in n different nodes. If the [n,k,d] code reaches the Singleton bound such that the minimum Hamming distance satisfies d=n−k+1, then the code is maximum distance separable (MDS) and offers redundancy-reliability optimality. With an [n,k] MDS erasure code, the original file can be recovered from any set of k encoded fragments, regardless of whether they are systematic or parity. In other words, the system can tolerate up to (n−k) concurrent device/node failure without jeopardizing the data availability.

Despite the huge potentials of MDS erasure codes, however, practical application of these codes in massive storage networks have been difficult. Not only are simple (i.e. requires very little computational complexity) MDS codes very difficult to construct, but data repair would in general require the access of k other encoded fragments, causing considerable input/output (I/O) bandwidth that would pose huge challenges to a typical storage network.

Motivated by the desire to reduce repair cost in the design of erasure codes for distributed storage systems, the notion of symbol locality was introduced in linear codes. The ith coded symbol of an [n,k] linear code C is said to have locality r(1≦r≦k) if it can be recovered by accessing at most r other symbols in C. The concept was further generalized to (r,δ) locality, to address the situation of multiple device failures.

The ith code symbol cᵢ, 1≦i≦n, in an [n,k] linear code C is said to have locality (r,δ) if there exists an index set Sᵢ⊂[n] containing i such that |Sᵢ|−δ+1≦r and each symbol cⱼ, j∈Sᵢ, can be reconstructed by any |Sᵢ|−δ+1 symbols in {c₁; l∈Sᵢ and l≠j}, where δ≧2 is an integer. Thus, when δ=2, the notion of (r,δ) locality reduces to the notion of r locality. Two cases of (r,δ) codes are introduced in the literature: An (r,δ)ᵢ code is a systematic linear code whose information symbols all have locality (r,δ); and an (r,δ)ₐ code is a linear code all of whose symbols have locality (r,δ). Hence, an (r,δ)ₐ code is also referred to as having all-symbol locality (r,δ), and an (r,δ)ₐ code is also referred to as having information locality (r,δ). A symbol with (r,δ) locality—given that at most (δ−1) symbols are erased—can be deduced by reading at most r other unerased symbols.

Clearly, codes with a low symbol locality, such as r<k, impose a low I/O bandwidth and repair cost in a distributed storage system. In a DSS system, one can use “group” to describe storage nodes situated in the same physical location which enjoy a higher communication bandwidth and a shorter communication distance than storage nodes belonging to different groups. In the case of node failure, a locally repairable code makes it possible to efficiently recover data stored in the failed node by downloading information from nodes in the same group (or in a minimal number of other groups). FIG. 16 provides a simple example of how an (r,δ)ₐ code is used to construct a distributed storage system. In this example, C is a(2,3)ₐ linear code of length 12 and dimension 5. Note that a failed node can be reconstructed by accessing only two other existing nodes, while it takes five existing nodes to repair a failed node if a [12,5] MDS code is used.

Locality was identified as a repair cost metric for distributed storage systems by introducing the concept of symbol locality of linear codes and establishing a tight bound for the redundancy in terms of the message length, the distance, and the locality of information coordinates. For a generalized concept, i.e., (r,δ) locality, the minimum distance d of an (r,δ)ᵢ linear code C is upper bounded by Equation 54:

$$d \leq n - k + 1 - ( ⌈ \frac{k}{r} ⌉ - 1 ) ( δ - 1 ) \qquad ( 54 )$$

where n and k are the length and dimension of C respectively. A class of codes known as pyramid codes may achieve this bound. Since an (r,δ)ₐ code is also an (r,δ)ᵢ code, (54) also presents an upper bound for the minimum distance of (r,δ)ₐ codes.

An (r,δ)ₐ code (systematic or not) is also termed a locally repairable code (LRC), and (r,δ)ₐ codes that achieve the minimum distance bound are called optimal. There exists optimal locally repairable linear codes when (r+δ−1)|n and q>kn^{k}.

Under the condition that (r+δ−1)|n, a construction method of optimal locally repairable vector codes was proposed, where maximal rank distance (MRD) codes were used along with MDS array codes. For the special case of δ=2, it was proposed an explicit construction of optimal LRCs when)

(r+1)|n

or

n mod(r+1)−1≧k mod r>0

Except for the special case that n mod (r+1)-1≧k mod r>0, no results are known about whether there exists optimal (r,δ), code when (r+δ−1)|n. Up to now, designing LRCs with optimal distance remains an intriguing open problem for most coding parameters n,k,r and δ. Since large fields involve rather complicated and expensive computation, a related interesting open problem asks how to limit the design (of optimal LRCs) over relatively smaller fields.

Algorithm to Construct Optimal (r,δ)ₐ Linear Codes

We investigate the structure properties and the construction of optimal (r,δ)ₐ linear codes of length n and dimension k. A simple property of optimal (r,δ)ₐ linear codes is proved, which shows that

$$\frac{n}{r + k - 1} \geq \frac{k}{r}$$

for any optimal (r,δ)ₐ linear code. Hence we impose this condition of

$$\frac{n}{r + k - 1} \geq \frac{k}{r}$$

throughout our discussion of optimal (r,δ)ₐ codes.

We prove a structure theorem for the optimal (r,δ)ₐ linear codes for r|k. This structure theorem indicates that it is possible for optimal (r,δ)ₐ linear codes, a sub-class of optimal (r,δ)ᵢ linear code, to have a simpler structure than otherwise.

We prove that there exist no optimal (r,δ)ₐ linear codes for

(r+δ−1)|n and r|k (55)

or

m<v+δ−1 and u≧2(r−v)+1 (56)

where n=w(r+δ−1)+m and k=ur+v such that 0<v<r and 0<m<r+δ−1.

We propose algorithm 1 for constructing optimal (r,δ)ₐ linear codes over any field of size

$$q \geq ( \begin{matrix}n \\ k - 1\end{matrix} )$$

when

(r+δ−1)|n (57)

or

m≧v+δ−1 (58)

where n=w(r+δ−1)+m and k=ur+v such that 0<v<r and 0<m<r+δ−1.

We propose algorithm 2 for constructing optimal (r,δ)ₐ linear codes over any field of size

$$q \geq ( \begin{matrix}n \\ k - 1\end{matrix} )$$

when

w≧r+δ−1−m and r−v≧u (59)

or

w+1≧2(r+δ−1−m) and 2(r−v)≧u (60)

where n=w(r+δ−1)+m and k=ur+v such that 0<v<r and 0<m<r+δ−1.

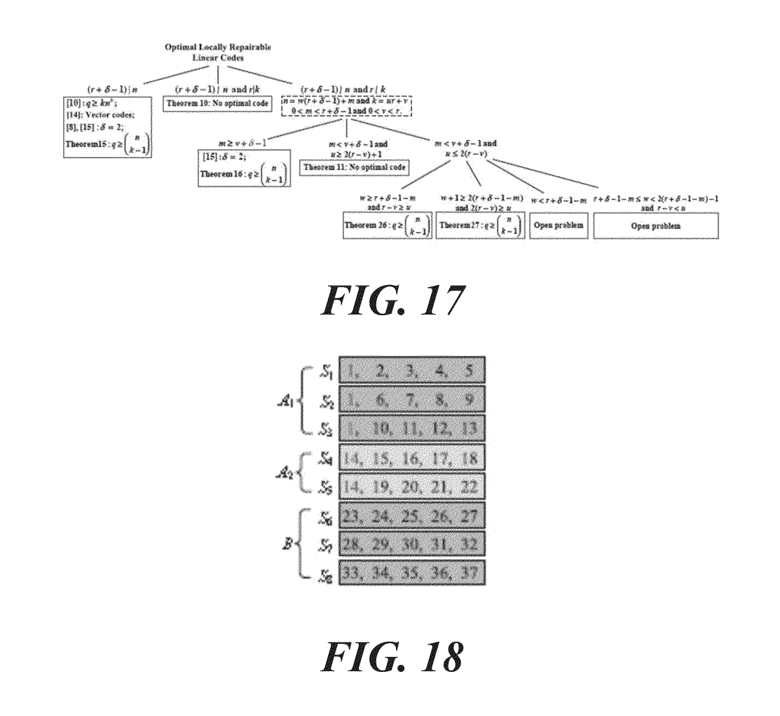

A summary of our results is given in FIG. 17. Note that if none of the conditions in (55)-(58) holds, it then follows that

m<v+δ−1 and u≦2(r−v).

In that case, if condition (59) does not hold, we have w<r+δ−1−m or r−v<u; and if condition (60) does not hold, we have w+1<2(r+δ−1−m), i.e., w<2(r+δ−1−m)−1. Hence, if, neither condition (59) nor condition (60) holds (in addition to (55)-(58)), then one of the following two conditions must be satisfied:

w<r+δ−1−m, (61)

or

r+δ−1−m≦w<2(r+δ−1−m)−1 and r−v<u (62)

In other words, if none of the conditions (55)-(60) holds, then either (61) or (62) will hold. From our existence proof and/or constructive results, the existence of optimal (r,δ)ₐ linear code is not known only for a limited scope with parameters described by (61) and (62).

We develop the following generic method to construct optimal (r,δ)ₐ linear codes. In this method, a generating matrix G=(G₁, . . . , Gₙ) of the optimal code C is constructed in four steps. In the first step, construct a collection of index sets, say, S₁, . . . , Sₜ, which are the candidates of indices of local MDS code. In the second step, select a subset from each index sets of step 1 to form one index set which is the candidate of indices of the largest MDS code contained in the final optimal (r,δ)ₐ linear codes. In the third step, build a sub-matrix G⁰, consisting of a subset of columns of G, such that G⁰ is a generating matrix of a maximum distance separable (MDS) code. In the final step, construct the other columns of G, one by one, such that some special property is satisfied.

In the following we describe two specific algorithms that follow the above method to construct the optimal (r,δ)ₐ linear codes shown in FIG. 17.

### Algorithm 1

If

$$q \geq ( \begin{matrix}n \\ k - 1\end{matrix} ) ,$$

then we can construct an optimal (r,δ)ₐ linear code of length n and dimension k over F_{q} such that for each subset Sᵢ and each code symbol cᵢ in Sᵢ, cᵢ can be reconstructed by any |Sᵢ|−δ+1 other symbols in Sᵢ. Specifically, we have the following construction. A collection of subsets of indexes S={S₁, . . . , Sₜ}. E,g, S={{1,2,3}, {4,5,6}, {7,8,9}, {10,11,12}, {13,14}} are constructed where two conditions must be satisfied. These subsets are disjoint and their union is the full set of indexes. The union of any ┌k/r┐ subsets contains at least

$$k + ⌈ \frac{k}{r} ⌉ ( δ - 1 )$$

indexes. A subset S⊂[n] is called an (S,r)-core if S intersect each Sᵢ with at most |Sᵢ|−δ+1. Additionally, if S is an (S,r)-core and S contains k indexes, then S is called an (S,r,k)-core.

A subset is picked from each subset of indexe Sᵢ and formed into a subset by taking union. E.g. pick {1,2},{5,6},{7,8},{10,12},{13} and form {1,2,5,6,7,8,10,12,13}. In general, from each subset Sᵢ, pick a subset Uᵢ⊂Sᵢ such that Uᵢ contains |Sᵢ|−δ+1 indexes. Then form a set Ω₀ by taking union, i.e., the set Ω₀ is the union of all Uᵢs.

A generator matrix for MDS code of size |Ω₀| is constructed which is used as the column of the final generator matrix, where the columns are indexed by the set Ω₀, e.g. the third column of the MDS generator matrix will be in the fifth column of the final generator matrix. E.g. (G₁,G₂,G₅,G₆,G₇,G₈,G₁₀,G₁₂,G₁₃), where each Gᵢ is a column of the generator matrix.

Fill in other columns of G according to certain properties. This can be achieved by the following process:

| | |
|---|---|
| 1 | Let Ω = Ω₀; |
| 2 | i runs from 1 to t; |
| 3 | While Sᵢ\Ω ≠ |
| 4 | Pick a λ ε Sᵢ\Ω and let Λ be the set of all S₀ ⊂ Ω such that S₀ ∪{λ} is an (S, r, k)- core; |
| 5 | Let G_{λ} ε<{Gₗ}_{lεSi∩Ω}>\(∪_{S}_{₀}_{εΛ}<{Gₗ}_{lεS}_{₀}>); |
| 6 | Ω = Ω ∪{λ}; |

By the above process, we can obtain a matrix G=(Gₗ, . . . , Gₙ) over F_{q}. Let C be the linear code generated by G. Then C is an optimal (r,δ)ₐ linear code over F_{q}. When (r+δ−1)|n or n mod (r+δ−1)−(δ−1)≧k mod r>0, we can construct an optimal (r,δ)ₐ linear code C of length n and dimension k over F_{q} by the above method, where

$$q \geq ( \begin{matrix}n \\ k - 1\end{matrix} ) .$$

For the case of (r+δ−1)|n, we simply let {S₁, . . . , Sₜ} be a partition of [n] such that |Sᵢ|=r+δ−1, ∀i∈[t], where

$$t = \frac{n}{r + δ - 1} .$$

For the case of n mod (r+δ−1)−(δ−1)≧k mod r>0, we let {S₁, . . . , Sₜ} be a partition of [n] such that |Sᵢ|=r+δ−1 for i∈{1, . . . , t−1} and |Sₜ|=n mod (r+δ−1). Then use the above method, we can construct an optimal (r,δ)ₐ linear code over F_{q}.

### Algorithm 2

If

$$q \geq ( \begin{matrix}n \\ k - 1\end{matrix} ) ,$$

then we can construct an optimal (r,δ)ₐ linear code of length n and dimension k over F_{q} such that for each subset Sᵢ and each code symbol cᵢ in Sᵢ, cᵢ can be reconstructed by any r other symbols in Sᵢ. Specifically, we have the following construction. A collection of subsets of indexes S={S₁, . . . , Sₜ} is constructed. The indexes can be overlapping. E.g., S={{1,2,3,4,5}, {1,6,7,8,9}, {1,10,11,12,13} }, {{14,15,16,17,18}, {14,19,20,21,22}}, {{23,24,25,26,27}, {28,29,30,31,32}, {33,34,35,36,37}}. [{1,2,3,4,5},{1,6,7,8,9},{1,10,11,12,13}]←-one cluster, common point is 1. [{14,15,16,17,18},{14,19,20,21,22}]←-one cluster, common point is 14. [{23,24,25,26,27}]←-one cluster. [{28,29,30,31,32}]←-one cluster. [{33,34,35,36,37}]←-one cluster. This example is shown in FIG. 18.

Numbers in any two clusters must be disjoint, within the same cluster, all subsets need to have exactly only one common point, and different cluster can have different number of subset. In general, there is a collection A={A₁, . . . , A_{α},B} which is a partition of [t] and a subset Ψ={ξ₁, . . . , ξ_{α}}⊂[n] such that the following conditions are satisfied: for each j∈[α], {ξⱼ}=n_{i∈A}_{ⱼ}Sᵢ and {Sᵢ\{ξⱼ}; i∈Aⱼ} are mutually disjoint; {U_{i∈A}_{ⱼ}Sᵢ; j∈[α]}∪{Sⱼ; j∈B} is a partition of [n]; the union of any

$$⌈ \frac{k}{r} ⌉$$

subsets contains at lease

$$k + ⌈ \frac{k}{r} ⌉ ( δ - 1 )$$

indexes.

A subset S⊂[n] is said to be an (S,r)-core if the following three conditions hold: If j∈[α] and ξⱼ∈S, then |S∩Sᵢ|≦r,∀i∈Aⱼ; if j∈[α] and ξⱼ∉S, then there is an iⱼ∈Aⱼ such that |SΩSᵢⱼ|≦r and |S∩Sᵢ|≦r−1, ∀i∈Aⱼ\{iⱼ}; if i∈B, then |S∩Sᵢ|≦r. Additionally, if S⊂[n] is an (S,r)-core and |S|=k, then S is called an (S,r,k)-core.

Then a subset is selected from each subset of indexes Sᵢ and form a subset by taking union. E.g. pick {1,2,3},{1,6,7},{1,10,11},{14,15,16},{14,19,20},{23,24,25},{28,29,30}, {33,34,35} and form {1,2,3,6,7,10,11,14,15,1619,20,23,24,25,28,29,30,33,34,35}. In general, for each j∈[α] and i∈Aⱼ, pick a Uᵢ⊂Sᵢ such that |Uᵢ|=r and ξⱼ∈Uᵢ. For each i∈B, pick a Uᵢ⊂Sᵢ such that |Uᵢ|=r. Let Ω₀=∪_{i∈[t]}Uᵢ.

A generator matrix for MDS code of size |Ω₀| is constructed which is used as the columns of the final generator matrix, where the columns are indexed by the set Ω₀, e.g. the fourth column of the MDS generator matrix will be in the sixth column of the final generator matrix. E.g. (G₁,G₂,G₃,G₆,G₇,G₁₀,G₁₁,G₁₄,G₁₅,G₁₆,G₁₉,G₂₀,G₂₃,G₂₄,G₂₅,G₂₈,G₂₉,G₃₀,G₃₃,G₄,G₃₅), where each Gᵢ is a column of the generator matrix.

Fill in other columns according to certain properties. This can be achieved by the following process:

| | |
|---|---|
| 1 | Let Ω = Ω₀; |
| 2 | i runs from 1 to t; |
| 3 | While Sᵢ\Ω ≠ |
| 4 | Pick a λ ε Sᵢ\Ω and let Λ be the set of all S₀ ⊂ Ω such that S₀ |
| | ∪{λ} is an (S,r,k)- core; |
| 5 | Let G_{λ} ε<{Gₗ}_{lεSi∩Ω}>\(∪_{S}_{₀}_{εΛ}<{Gₗ}_{lεS}_{₀}>); |
| 6 | Ω = Ω ∪{λ}; |

By Algorithm 2, we can obtain a matrix G=(G₁, . . . , Gₙ) over F_{q}. Let C be the linear code generated by G. Then C is an optimal (r,δ)ₐ linear code over F_{q}. When 0<n mod (r+δ−1)<k mod r+(δ−1), with other additional conditions, we can construct an optimal (r,δ)ₐ linear code C of length n and dimension k over F_{q} by the above method, where

$$q \geq ( \begin{matrix}n \\ k - 1\end{matrix} ) .$$

For example, suppose w≧r+δ−1−m and r−v≧u, where n=w(r+δ−1)+m and k=ur+v such that 0<m<r+δ−1 and 0<v<r. We let {S₁, . . . , Sₜ} be a collection of (r+δ−1)−subsets of [n] such that S₁, . . . , Sₗ₊₁ have a common element and ∪ᵢ₌₁^{t}Sᵢ=[n], to where l=r+δ−1−m. Then use the above method, we can construct an optimal (r,δ)ₐ linear code over F_{q}.

Suppose w+1≧2 (r+δ−1−m) and 2(r−v)≧u, where n=w(r+δ−1)+m and k=ur+v such that 0<m<r+δ−1 and 0<v<r. We let {S₁, . . . , Sₜ-} be a collection of (r+δ−1)-subsets of [n] such that S₂ᵢ₋₁ and S₂ᵢ have a common element (1=1, . . . , I) and ∪^{t}ᵢ₌₁Sᵢ=[n], where l=r+δ−1−m. Then use the above method, we can construct an optimal (r,δ)ₐ linear code over F_{q}.

Thus it can be seen that systems and methods for distributed storage systems that are highly recoverable and relatively impervious to failure have been disclosed which provide many advantages. While several exemplary embodiments have been presented in the foregoing detailed description of the invention, it should be appreciated that a number of variations may exist, including variations as to the system structure, operation and methodologies of the distributed storage systems.

It should further be appreciated that the exemplary embodiments are only examples, and are not intended to limit the scope, applicability, dimensions, or configuration of the invention. Rather, the foregoing detailed description will provide those skilled in the art with a convenient road map for implementing an exemplary embodiment of the invention, it being understood that various changes may be made in the systems and methodologies of the exemplary embodiments without departing from the scope of the invention as claimed.

1. A systematic distributed storage system (DSS) comprising:
a plurality of storage nodes, wherein each storage node is configured to store one of a plurality of coded blocks, the coded blocks being linearly encoded from sub-blocks of a data file, each coded block being stored at a unique one of the storage nodes; the linear encoding consisting of XOR operations on the sub-blocks; and
a set of repair pairs of the storage nodes, for each of the storage nodes;
wherein the system is configured to use the respective repair pair of storage nodes to repair a lost or damaged coded block on a given storage node; and wherein the repair pairs include one or more alternate pairs.

2. The system in claim 1 wherein the coded blocks are Non Maximum Distance Separable.

3. (canceled)

4. The system in claim 1 wherein the coding is binary Simplex coding.

5-7. (canceled)

8. A distributed storage system DSS comprising
h non-empty nodes; and
data stored non-homogenously across the non-empty nodes according to the storing codes (n,k).

9. The system in claim 8 wherein the h non-empty nodes each having respective non-homogenous bandwidths.

10. The system in claim 8 wherein one of the non-empty nodes is a super-node with a significantly higher bandwidth, reliability and/or storage capacity than the remaining non-empty nodes, and a significantly higher proportion of the data is stored on the super-node.

11. The system in claim 10 wherein the super-node is a local host.

12. The system in claim 10 wherein the super-node is configured to store two or more systematic data sub-blocks using Maximum Distance Separable Coding.

13. The system in claim 10 wherein the super-node is configured to store two or more systematic data sub-blocks using Non Maximum Distance Separable Coding.

14. The system in claim 10 wherein the super-node is configured to store two or more parity data sub-blocks using Maximum Distance Separable Coding.

15. The system in claim 8 configured to optimise the distribution of data across the non-empty nodes to minimise the repair bandwidth and/or the download cost.

16. The system in claim 15 where h non-empty nodes store the same amount of information.

17. The system in claim 15 where h−1 non-empty nodes store the same amount of information.

18. The system in claim 8 further comprising a plurality of empty nodes and the method further comprising minimising h.

19. A method for determining linear erasure codes with local repairability comprising,
selecting two or more coding parameters including r and δ;
determining if an optimal [n, k, δ] code having all-symbol (r, δ)-locality (“(r, δ)ₐ”) exists for the selected r, δ; and
if the optimal (r, δ)ₐ code exists performing a local repairable code using the optimal (r, δ)ₐ code.

20. The method in claim 19 wherein the coding parameters further including n and k.

21. The method in claim 20 further comprising determining the lower bound of the required field size.

22. The method in claim 19 wherein when the coding parameters satisfy:
w≧r+δ−1−m and r−v≧u a)
or
w+1≧2(r+δ−1−m) and 2(r−v)≧u b)
(r+δ−1)|n, or c)
m≧(v+δ−1) d)
an optimal (r, δ)ₐ code exists.

23. The method in claim 22 further comprising determining an optimal (r, δ)ₐ code using a first algorithm for (a) and (b) and a second algorithm for (c) and (d).

24. The method in claim 21 wherein the lower bound is determined using
$$( \begin{matrix}n \\ k - 1\end{matrix} ) .$$

25. The method in claim 19 wherein when the coding parameters satisfy:
(r+δ−1)|n and r|k e)
or
m<v+δ−1 and u≧2(r−v)+1 f)
no optimal (r, δ)ₐ code exists.

26. The system of claim 1 wherein the linear encoding comprises:
$${z}_{j} = ( \begin{matrix}{α}_{j , 1} & {α}_{j , 2} & … & {α}_{j , r}\end{matrix} ) ( \begin{matrix}{o}_{i , 1} \\ {o}_{i , 2} \\ ⋮ \\ {o}_{i , r}\end{matrix} ) = {\sum }_{l = 1}^{r} {α}_{j , l} {o}_{i , l} ,$$
where o_{i,1}, . . . , o_{i,r} are the sub-blocks of the data file,
$$i = ⌊ \frac{j - 1}{{2}^{r} - 1} ⌋ + 1 , {α}_{j , l} ∈ {F}_{2} ( 1 \leq l \leq r ) ,$$
and (α_{j,1} α_{j,2} . . . α_{j,r}) is the binary representation of
$$j - ⌊ \frac{j - 1}{{2}^{r} - 1} ⌋ ( {2}^{r} - 1 )$$
and └ ┘ represents the integer floor.

27. The system of claim 4 wherein the simplex coding further comprises an added all-ones vector and then an overall parity check.
